(19) United States
(12) Patent Application Publication
(10) Pub. No.: US 2025/0360624 A1
(43) Pub. Date: Nov. 27, 2025

(54) SYSTEM AND METHOD FOR A COMMERCIAL DISHWASHING ROBOT

(71) Applicant: Armstrong Robotics, Inc., San Francisco, CA (US)

(72) Inventors: Axel Hansen, San Francisco, CA (US); Jonah Varon, San Francisco, CA (US); Luke Hansen, San Francisco, CA (US); Samuel Pannepacker, San Francisco, CA (US); Sungbum Park, San Francisco, CA (US); Matthew LoGrasso, San Francisco, CA (US)

(73) Assignee: Armstrong Robotics, Inc., San Francisco, CA (US)

(21) Appl. No.: 18/810,156

(22) Filed: Aug. 20, 2024

Related U.S. Application Data
(60) Provisional application No. 63/651,621, filed on May 24, 2024.

(51) Int. Cl. B25J 9/16; B25J 15/04; B25J 15/08

(52) U.S. Cl. CPC B25J 9/1687; B25J 9/1682; B25J 9/1697; B25J 15/04; B25J 15/08

(57) ABSTRACT

A robotic apparatus is proposed that automatically loads and/or unloads a dishwasher. One embodiment includes two or more robotic arms that work together to load dirty tableware into a dishwasher. The same robotic arms, or one or more different robotic arms, can be used to automatically remove clean tableware from the dishwasher after a washing cycle and place (or stack) the clean tableware in appropriate locations.

This application claims the benefit of Provisional Application 63/651,621 filed May 24, 2024, titled “System And Method For A Commercial Dishwashing Robot,” incorporated herein by reference in its entirety.

### FIELD

The disclosure generally relates to robotic systems.

### BACKGROUND

Various tasks lend themselves to automation. Stand-alone robots may be used to perform them. Some tasks, however, may require an autonomous robot to reach and manipulate objects located in a dynamic and space-constrained environment. Commercial dishwashing is one such task. Typical commercial dish rooms in restaurants, cafes, hotels, corporate cafeterias, universities, retirement homes, airports, and other facilities are generally space-constrained and often do not have space to accommodate a large, standalone robotic system.

Commercial dishwashing has several other constraints and requirements that make automation challenging. Physical modifications to and retrofitting of the dish room must be minimal, because dish rooms vary widely. The robot may not be strong enough to manipulate large, heavy cookware items, so it must allow room for staff to wash those items. Speed and throughput are important, because dish rooms often must wash hundreds to thousands of tableware per hour. The robot should be able to reach the dishwasher, water sprayer, sink, and garbage, and should be able to transform its geometry into a configuration that does not block access to them when not in use. When handling dirty tableware before washing, the robot should also handle stacked or piled up tableware, tableware in arbitrary configurations, and tableware that are occluded by food waste. When handling clean tableware after washing, the robot should neatly stack and sort the tableware.

Typical midsize commercial dish rooms use either a door-type dishwasher or a conveyor-type machine. Both these types of dishwashers support a workflow where staff load dirty tableware into a standard-sized (appx. 19.75″ square) commercial dish rack, the dish rack enters the dishwasher on one side (the “dirty side”), the machine sanitizes the tableware, and the sanitized rack exits the machine on another side (the “clean side”). Typically, the dirty side of the dishwasher is adjacent to a sink where tableware can be pre-sprayed. Typically, one or more garbage cans or waste receptacles are placed near the dirty side of the dishwasher, and staff scrape food waste off the dirty tableware into the garbage.

### SUMMARY

A robotic apparatus is proposed that automatically loads and/or unloads a dishwasher. One embodiment includes two or more robotic arms that work together to load dirty tableware into a dishwasher. The same robotic arms, or one or more different robotic arms, can be used to automatically remove clean tableware from the dishwasher after a washing cycle and place (or stack) the clean tableware in appropriate locations.

### BRIEF DESCRIPTION OF THE DRAWINGS

FIGS. 1-5 depict a dishwasher and robotic arms configured to load dirty tableware into the dishwasher.

FIGS. 6 and 7 depict two robotic arms that together manipulate tableware.

FIGS. 8-12D depict one example of a finger attachment connected to a gripper.

FIG. 13 provides examples of tableware.

FIGS. 14-19 depict another example of a finger attachment, referred to as the plate bite fingers.

FIGS. 20-27 depict another example of a finger attachment, referred to as the magnetic finger attachment.

FIGS. 28-31 depict another example of a finger attachment, referred to as the plier fingers.

FIGS. 32-35 depict another example of a finger attachment, referred to as the alligator fingers.

FIG. 36 depicts a dishwasher and robotic arms configured to load dirty tableware into the dishwasher and unload clean tableware from the dishwasher.

FIG. 37 depicts a dishwasher and robotic arms configured to load dirty tableware into the dishwasher and unload clean tableware from the dishwasher.

FIG. 38 depicts a dishwasher and robotic arms configured to load dirty tableware into the dishwasher and unload clean tableware from the dishwasher.

FIGS. 39 and 40 depict a robotic arm configured to unload clean tableware from the dishwasher.

FIGS. 41A and 41B depict a robotic arm manipulating drawers that hold clean tableware.

FIG. 42 depicts a dishwasher and robotic arms configured to load dirty tableware into the dishwasher and unload clean tableware from the dishwasher.

FIG. 43 is a block diagram of the electrical components of the robotic arms.

FIG. 44 is a flow chart describing one embodiment of a process for operating robotic arms configured to load dirty tableware into the dishwasher.

FIG. 45 is a flow chart describing one embodiment of a process for identifying tableware at a dishwasher.

FIG. 46 is a flow chart describing one embodiment of a process for creating pick tasks.

FIG. 47 is a flow chart describing one embodiment of a process for estimating quality of each pick task.

FIG. 48 is a flow chart describing one embodiment of a process for planning.

FIG. 49 is a flow chart describing one embodiment of a process for executing planned operations.

FIG. 50 is a flow chart describing one embodiment of a process for operating robotic arms configured to load dirty tableware into the dishwasher.

### DETAILED DESCRIPTION

The present disclosure generally relates to robotic systems (including associated software) and, in particular, an adaptable robotic apparatus that can be installed in most typical commercial dish rooms with minimal modifications to the physical space.

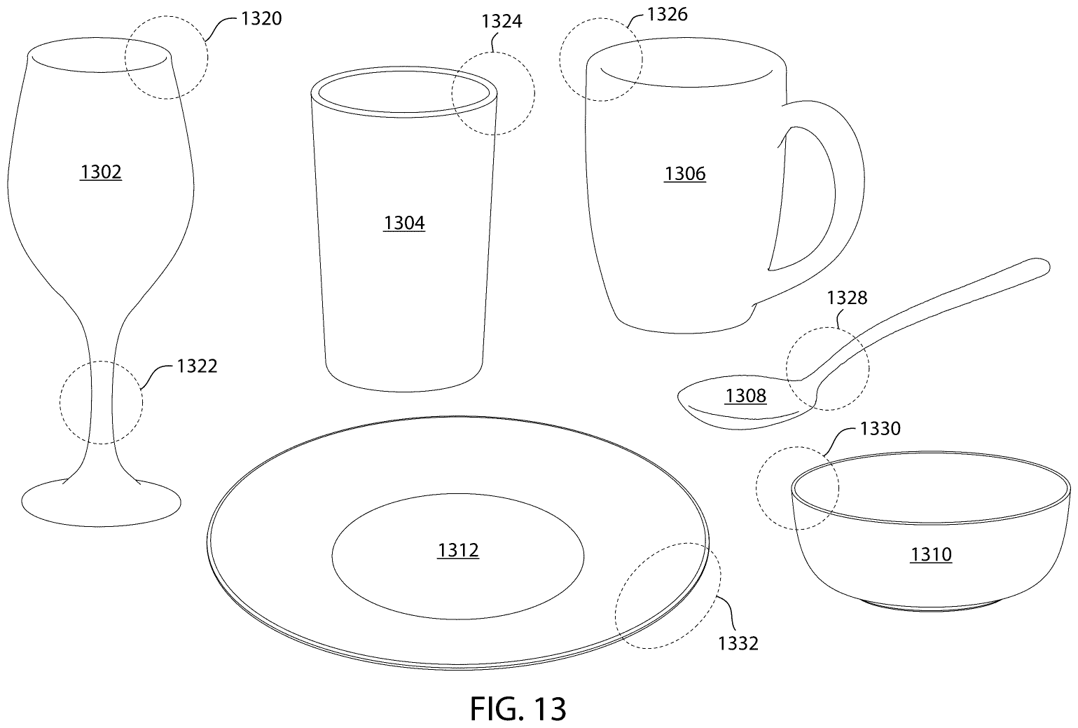

An adaptable dishwashing robot presently disclosed includes one or more vertical poles, and multiple horizontal rails which are rigidly attached to the pole(s) and to the dish room wall(s). At least two robotic arms are mounted on the rails, with one or more robotic arms positioned to manipulate dirty tableware, and (optionally) at least one robotic arm positioned to manipulate clean tableware. For purposes of this document, tableware comprises the objects used on a table at meals including (but not limited to) plates, dishes, cutlery/flatware (e.g., spoons, forks and knives) and glassware (e.g., cups, mugs, glasses, etc.). Examples of tableware are depicted in FIG. 13, along with visually distinctive points that a neural network can recognize on the tableware (referred to as key points).

One embodiment includes three robotic arms, where two robotic arms are positioned to manipulate dirty tableware, and one arm is positioned to manipulate clean tableware. In this embodiment, staff periodically place bus tubs full of dirty tableware near a designated area on the dirty side of the dishwasher. Two dirty side robotic arms coordinate with one another to pick dirty tableware out of the bus tub(s), optionally scrape large food waste into the trash can or other waste receptacle, optionally dump liquid into the sink, optionally rinse the dish into the sink using a water spraying device, and place the dish into the dish rack. Once the dish rack is full, one of the robotic arms pushes the dish rack into the dishwasher. Once the dishwasher runs, the robotic arm(s) on the clean side pulls the dish rack out of the dishwasher and unloads the tableware from the dish rack, inspecting them for cleanliness and stacking them onto the clean side dish table. The entire process is performed automatically. Human staff periodically remove the stacks of clean tableware and bring them back to the cook line.

Robotic arms can exert large dynamic forces as they move. Because of this, they require a strong, rigid structure to be mounted to. This structure must resist the dynamic loads from the arms, and must remain securely attached to the floor, walls, and/or ceiling of the environment. It must minimize the amount that it deforms or spatially migrates over time.

Restaurant dish rooms typically have a door-type dishwasher installed in either a corner configuration or a linear configuration along a single wall. The robotic arm apparatus described herein may be easily installed into either of those two common configurations.

For a corner configuration of a door-type commercial dishwasher, one or more poles may be placed near the corner of the dishwasher, to avoid blocking the walkway for staff. The rails may be attached to the pole, and may span the corner of the dish room, attaching to the walls on both sides of the dishwasher. This configuration provides a strong structure for mounting the robotic arms, because the pole and rails form a structure that relies on at least three distant and non-coplanar mounting points (two on the walls and one on the floor).

For a linear configuration of a door-type dishwasher, one or more poles may be used. The rails may attach to the wall behind the dishwasher and be mounted to at least one point on each side of the dishwasher. This configuration provides a strong structure for mounting the robotic arms, because the poles and rails form a structure that relies on at least four mounting points (at least two on the back wall and at least two on the floor).

In other embodiments, the vertical poles may extend all the way down to the floor, or alternatively may be connected to existing dish tables, which are typically welded in place. The horizontal rails may be extended, adjusted, or reconfigured based on the configuration of the dish room. The rails may connect to plates that are bolted into wall studs, or extended, adjusted or reconfigured so that they can be directly bolted into wall studs.

In all embodiments and configurations, the rails are positioned such that the robotic arms can be mounted to the rails and can reach objects (e.g., tableware) and work surfaces necessary to perform the dishwashing tasks. For example, the dirty side robotic arm(s) are positioned such that they can reach the dishwasher, the dirty side dish table, and optionally, the sink, water sprayer, trash can(s) or waste receptacle(s), and additional shelves or work surfaces. The clean side robotic arm(s) are positioned such that they can reach the dishwasher, the clean side dish table, and optionally, additional shelves or work surfaces. The robotic arms can change their positions to “fold” themselves to achieve a compact configuration, which minimally blocks the objects and work surfaces necessary to perform the dishwashing tasks. When the arms assume this compact configuration, staff can use the objects and work surfaces similarly to the way they would without the robot being installed.

In all embodiments and configurations, the rails serve as a structure for mounting robotic arms and other components, and also allow for electrical power cables to be routed along or through them to provide power to the robotic arms and other components. In addition to the robotic arms, the apparatus may include cameras, depth sensors, processors/computers and finger attachments.

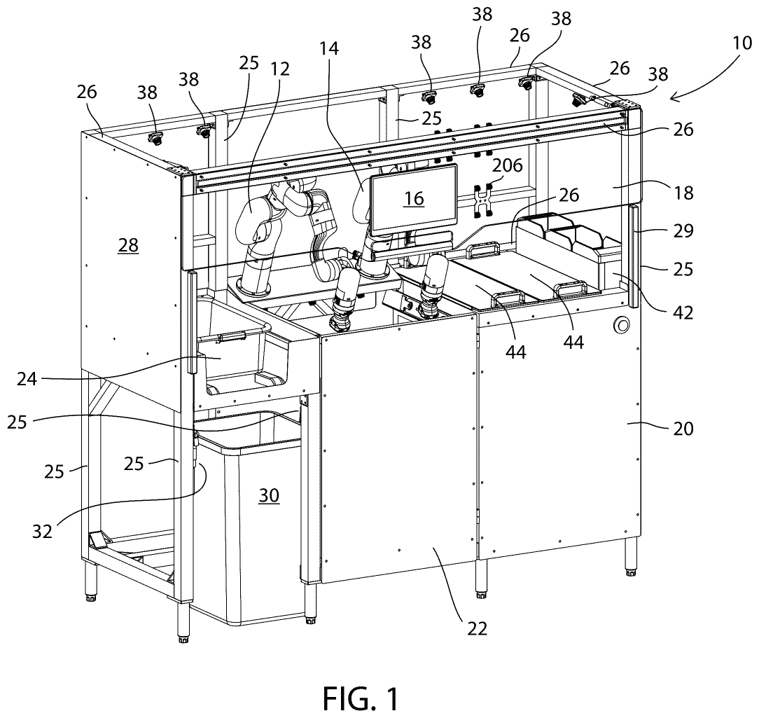

FIGS. 1-5 depict one embodiment of a robotic apparatus for arranging tableware that includes a commercial dishwasher 20 and robotic arms 12 and 14 that are configured to load dirty tableware into the dishwasher. A set of vertical poles 25 and horizontal rails 26 comprise a structure for mounting the robotic arms 12 and 14, as well as other components. The robotic apparatus further includes a control circuit 244 (includes one or more computers, controllers and/or processors), behind door 22, connected to robotic arms 12 and 14 for controlling robotic arms 12 and 14. A set of cameras 38 are mounted on rails 26 and are electrically connected to and communicate with control circuit 244. The cameras 38 are used to see the position and motion of all items at the robotic apparatus for arranging tableware. Cameras 38 include vision cameras (e.g., RGB) and depth cameras. Touch screen 16, connected control circuit 244, allows an operator to receive status from control circuit 244 and issue commands to control circuit 244.

Bus tub 24, adjacent to robotic arms 12 and 14, sits above and partially horizontally displaced from trash bin 30. Side panel 28 shields bus tub 24 from the kitchen. A human operator (or robot) working in the kitchen will place bus tub 24 into the position depicted in FIGS. 1-5 filled with dirty tableware that is randomly stacked and randomly arranged in bus tub 24. Safety shield 18 prevents debris/splatter from entering or leaving the apparatus.

Dishwasher 20 includes a dishwasher door 204 that can be opened using handle 202. Robotic arms 12 and 14 can grab handle 202 to open and close dishwasher door 204. Robotic arms 12 and 14 can operate dishwasher 20, including turning on power to dishwasher 20 and starting/running dishwasher 20 to clean a load of dirty tableware. When the dishwasher is open, a dish rack 302 can sit on the inside surface of door 202. On top of dishwasher 20 are clean dish trays 44 and clean utensil baskets 42.

Dish rack 302 can have many different configurations. Commercial dish rooms typically use three types of dish rack: peg racks, compartment glass racks, and open racks. Typically, multiple different rack types are loaded simultaneously. For example, dirty glasses are loaded into a compartment glass rack, and dirty plates are loaded into a peg rack. When a dish rack is full, it gets moved into and washed in the dishwasher.

However, in many embodiments of a commercial dishwashing robot, the arms cannot reach more than one or two dish racks. For example, in the one embodiment that includes two robotic arms positioned to manipulate dirty tableware together, the dirty-side arms may only be able to reach the dish rack being loaded and the dish rack in the dishwasher. In order to load and unload different types of tableware with this limited reach, the system may use dish racks that are designed to hold a combination of dish types. These combination dish racks have similar overall dimensions to standard full-size commercial dish racks (19.75 inches by 19.75 inches) or standard half-size commercial dish racks (19.75 inches by 10 inches).

One embodiment of a dish rack contains pegs of different heights, including pegs that are shorter than those in a typical commercial peg rack. This design allows a variety of cups, mugs, and glasses to be placed on top of the shorter pegs, with their rims still resting on the bottom of the rack. Another embodiment includes a section with a flat, mesh bottom, which allows flatware to be placed in that section. A third embodiment includes adjustable, removable dividers that can be moved to create compartments of different sizes to accommodate different types of tableware.

In some embodiments that include three robotic arms, there will be three full-size (19.75 inches by 19.75 inches) dish racks concurrently in use: a rack R1 being loaded with dirty tableware by the two dirty-side arms, a rack R2 being washed in the dishwasher, and a rack R3 that has been washed and is being unloaded by the one or more clean-side arms. In this embodiment, when the clean-side arm(s) has/have finished unloading clean rack R3, the clean side arm grasps rack R3 and passes R3 back to dirty side. In some embodiments, dish racks are stored on top of the horizontal rails above the clean-side arm(s), and are passed back to the dirty side arms when needed, based upon the type and quantity of dirty tableware detected.

In some embodiments, a food waste scraper 34 is above trash bin 30. The food waste scraper 34 can be used to scrape food waste off of tableware such as plates and bowls. The food waste scraper 34 is placed in a location such that one or more dirty-side robotic arms 12 and 14 can reach it. To use it, a dirty side arm moves a grasped tableware such as a plate from bus tub 24, then moves the tableware such that the food waste scraper is in contact with one edge of the plate, then moves the plate along the food waste scraper, maintaining contact with it, such that any food waste is scraped off and falls into the trash bin 30. In most embodiments, the robotic arms 12/14 and control circuit 244 use one or more cameras 38 or sensors to determine whether most of the food waste has been removed from the tableware, and if it has not, the robotic arm 12/14 repeats the scraping movement and inspects the tableware again afterward. The apparatus may also include a water sprayer 32 that can be grabbed by either robotic arm to spray water on tableware or the dish racks to clean/rinse off dirty tableware with water or other liquid.

In some embodiments, the cameras 38 and/or sensors mounted on the horizontal rails 26 are configured to implement a Virtual Safety Light Curtain. This Virtual Safety Light Curtain consists of one or more planes that are configured during setup using light curtain 29 to separate the robotic arms' workspace from the rest of the dish room. If a person or object crosses the plane(s) and enters the robotic arms' workspace, the robotic arms immediately pause their movement until the person or object exits the robotic arms' workspace. In some embodiments, the Virtual Safety Light Curtain is configured such that the planes are oriented vertically and run along the edges of the dish table(s) and approximately 12 inches surrounding the dishwasher. This configuration defines the arms' workspace as the union of the region above the dish table(s) and surrounding the dishwasher.

In general, control circuit 244 operates robotic arms 12 and 14 to pick up dirty tableware from bus tub 24, place the dirty tableware into dish rack 302, slide dish rack 302 into dishwasher 20, close door 204 using handle 202, run dishwasher 20, open door 204 after the dishwasher has cleaned the tableware in dish rack 302 and transfer the clean tableware from dish rack 302 to clean dish trays 44 and clean utensil baskets 42.

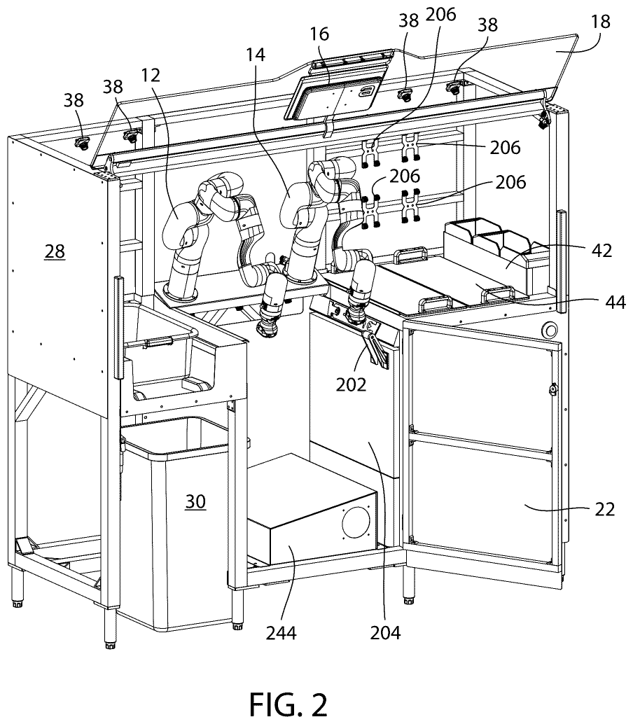

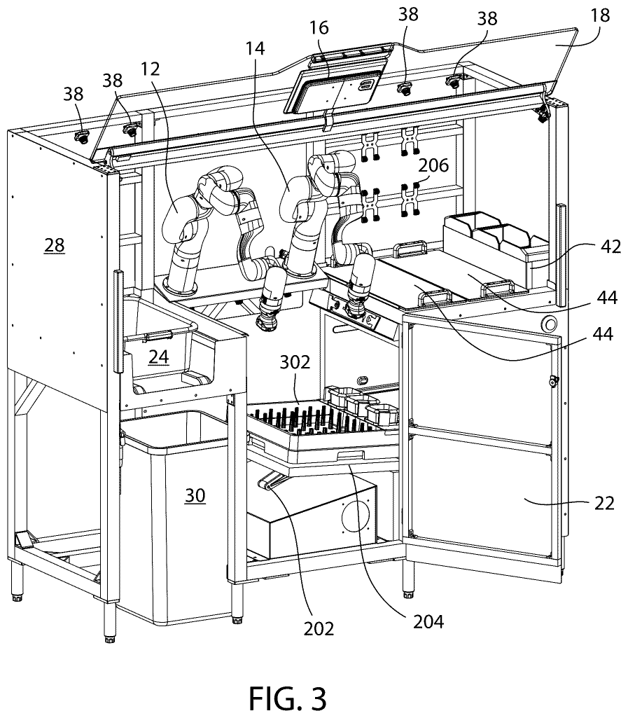

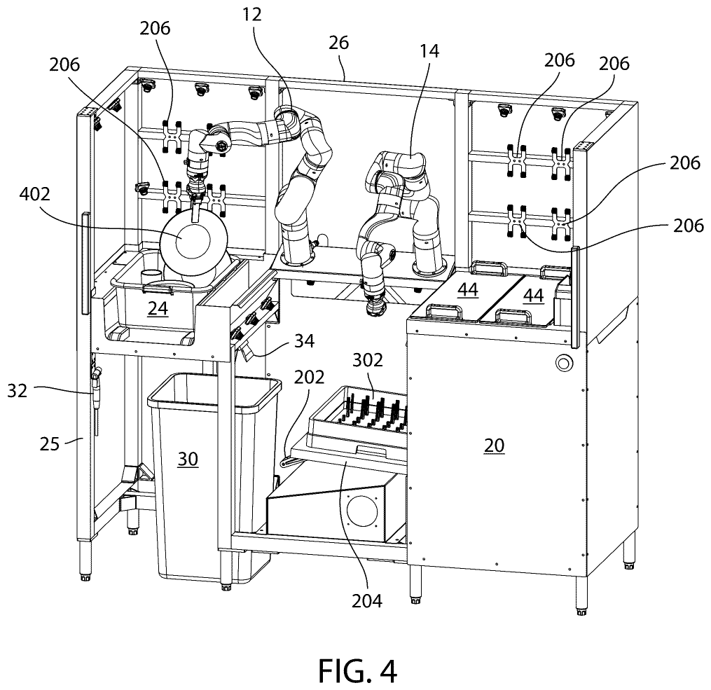

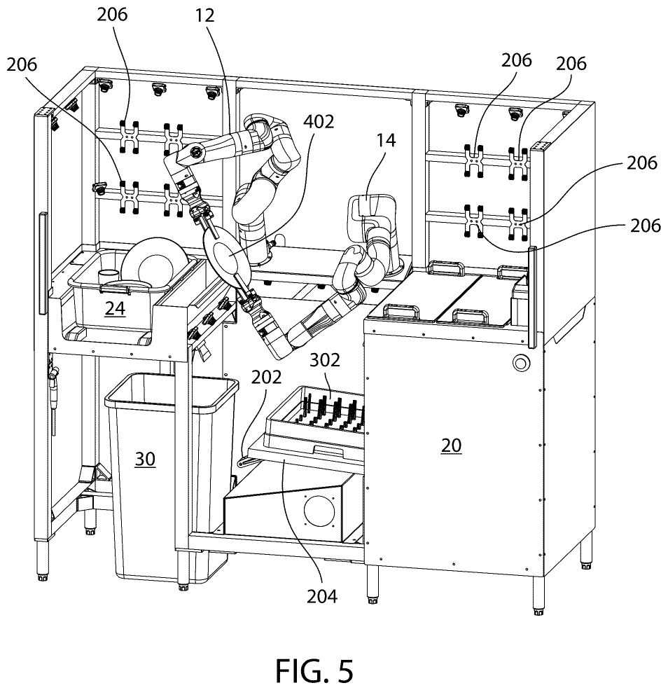

FIG. 2 depicts the robotic apparatus with door 22 open, exposing control circuit 244 housed in a box, handle 202 and dishwasher door 204. FIG. 3 depicts dishwasher door 204 opened with dish rack 302 positioned on top of dishwasher door 204 and safety shield 18 rotated up to an open position. FIG. 4 depicts robotic arm 12 grabbing tableware (e.g., plate 402) from bus tub 24. FIG. 5 depicts robotic arm 12 handing plate 402, which robotic arm 12 picked up from bus tub 24, to robotic arm 14 so that robotic arm 14 can place plate 402 into dish rack 302, as discussed in more detail below. In FIG. 5, robotic arm 12 and robotic arm 14 are holding plate 402 at the same time.

In one embodiment, robotic arms 12 and 14 work together to more efficiently load dirty tableware into the dish rack by having one robotic arm pick up an item of tableware and hand it to the second robotic arm which then places the item of tableware into the dish rack. For example, FIG. 5 shows an embodiment in which robotic arm 12 picks up a plate 402 from tub 24 and hands plate 402 to robotic arm 14 so that robotic arm 14 can then places plate 402 into dish rack 302. One reason for this type of coordination is that it may be difficult to position any single robotic arm such that it can access the tub 24 and dish rack 302 using the appropriate poses.

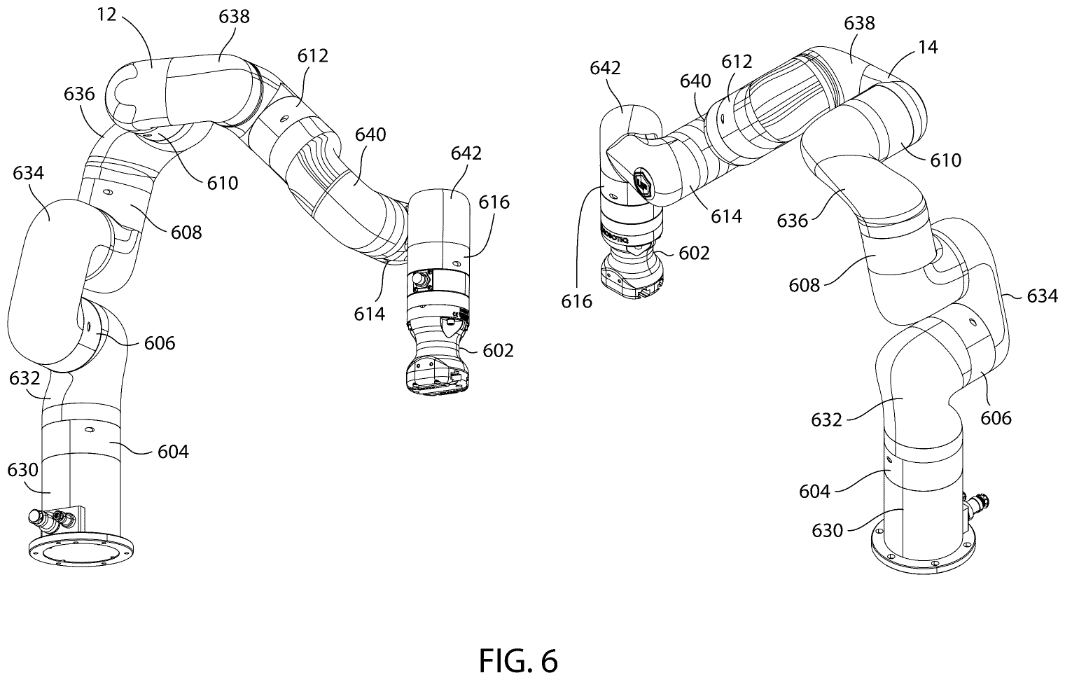

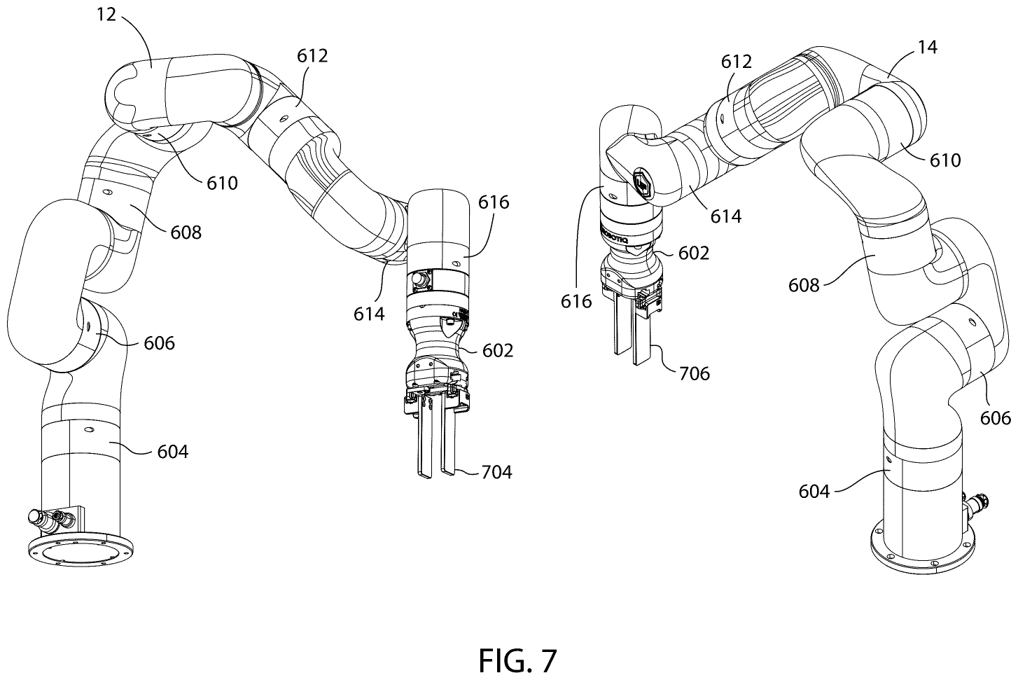

FIGS. 6 and 7 depict robotic arms 12 and 14. In one embodiment, robotic arms 12 and 14 comprise the exact same structure, while in other embodiments robotic arms 12 and 14 comprise different structures. The robotic arms 12 and 14 comprise multiple joints (e.g., 3-10 joints each) with arm segments (hereinafter referred to as segments) between the joints. In one embodiment, robotic arms 12 and 14 each comprise seven joints 604, 606, 608, 610, 612, 614 and 616. Segment 630 comprises the base of each arm and is mounted to one of the rails or another surface. Between joints 604 and 606 is segment 632. Between joints 606 and 608 is segment 634. Between joints 608 and 610 is segment 636. Between joints 610 and 612 is segment 638. Between joints 612 and 614 is segment 640. Between joints 614 and 616 is segment 642. In other embodiments, other structures or arrangements can be used. In one example embodiment, each joint comprises a motor connected to the two adjacent segments for pivoting the segments about the joint, a gear box for (connected to) the motor, an encoder for measuring rotation of the motor (i.e. measuring pivot angle of the adjacent segments), a brake connected to the motor to stop the motor, power electronics connected to the motor, and a control board. The control board comprises an electrical circuit (including a controller or processor) for controlling the joint and is connected to the motor, encoder, power electronics, brake, gear box, and control circuit 244 via wires that run inside the robotic arm and physically connect to control circuit 244 or via a wireless connection (e.g., Bluetooth or other protocol). In one embodiment, each of the robotic arms is an xArm7 from Shenzhen Ufactory Co. Ltd.

A commercial dish room is generally very space-constrained. Additionally, to achieve high speed and throughput of dishwashing, and to manipulate certain types of dirty tableware, in many cases, two or more arms 12 and 14 must be able to reach the same objects and work surfaces. This requires them to operate in close proximity to one another, and to share a single workspace. In order for two or more robotic arms to share a single workspace, they coordinate their motion to avoid colliding with one another and to avoid blocking one another's movement.

In order to coordinate the motion between two arms in a shared workspace, the work is organized into a multi-level hierarchy. In one embodiment, the work is organized into a hierarchy with three levels: Task Groups, Tasks, and Actions. A Task Group includes one or more Tasks, and a Task includes one or more Actions. A Task Group is the highest level grouping of work and is used for a complex but frequently repeated process. For example, a single Task Group may include all of the following: picking up a dirty dish from a bus tub, scraping, dumping, and/or rinsing it, and placing it into a dish rack. In this embodiment, a Task is a mid-level grouping of work, and is used for processes that are part of a Task Group. In the above example, the Task Group would include separate Tasks for each of the following: picking up a dirty dish from a bus tub; optionally scraping it; optionally dumping liquid from it; optionally rinsing it; and placing it into a dish rack. In this embodiment, an Action is a low-level grouping of work and is used for simple processes that are part of a Task. While a TaskGroup and a Task can operate using multiple arms, an Action may only operate on one arm. In the above example, the Task for picking up a dirty dish from a bus tub would include an Action for each of the following: moving the arm to a position near the dish, opening the gripper, moving the arm so that the gripper is positioned around the dish, closing the gripper, and moving the arm so that the grasped dish is removed from the bus tub.

Each Action has a unique identifier and stores the identifier of the arm on which it operates. Additionally, each action implements functions to predict which objects in the environment it will move or change, and how they will be changed. One such function returns a list of the unique identifiers of all the objects the Action will move or change. Another such function returns a Collision Trajectory, which is the path through space of each object that the Action may move or change, including the arm it operates on. To generate a Collision Trajectory from an Action, we first divide the Action's expected motion into Waypoints, which are discrete steps. Each Waypoint represents a point in time during the period when the Action will be executed. Each Waypoint includes the geometry of each object that the action may move or change at that point in time. An Action's Collision Trajectory includes all the Action's Waypoints.

Similar to Actions, each Task and Task Group implements functions to predict which objects in the environment it will move or change, and how they will be changed. In most cases, a Task implements these functions by simply calling the equivalent functions on all its constituent Actions, and concatenating or combining the results. In most cases, a Task Group implements these functions by simply calling the equivalent functions on all its constituent Tasks, and concatenating or combining the results.

Each Action, Task, and Task Group implements a function to return a GoalPost, which is a unique identifier that represents the point in time when the Action, Task, or Task Group finishes executing. These GoalPosts, together with the Collision Trajectories, can be used to schedule and plan complex tasks using collision-free motions of the arms, and coordinate the arms with one another, as described below.

Each Action, Task, and Task Group can be designated as dependent upon the GoalPost of another Action, Task, or Task Group. There are two types of dependencies: (1) WaitUntil and (2) YieldUntil. If an Action, Task, or TaskGroup A is designated to WaitUntil the GoalPost G of another Action, Task, or TaskGroup B, A will only be executed once G has been reached (which occurs when B has finished executing).

If an Action, Task, or TaskGroup A is designated to YieldUntil the GoalPost G of another Action, Task, or TaskGroup B, A may execute before G has been reached, but only if doing so will not obstruct B's execution. In this scenario, the coordination system uses the Collision Trajectories of A and B in order to determine whether it is possible for A to execute before G has been reached, while B is still executing. To calculate this, the Collision Trajectories of A and B are superimposed, and the Waypoints in the Collision Trajectory of B that overlap, or collide with, Collision Trajectory A, are returned. In some cases, only the last overlapping Waypoint W in Collision Trajectory B is returned for efficiency. Then, as B is being executed, A pauses until W has been reached. Once W has been reached, A begins executing.

An Action, Task, or TaskGroup A can execute in RunAhead mode. In RunAhead mode, if A's Collision Trajectory collides with the Collision Trajectory of another Action, Task, or TaskGroup B, but A can also complete its execution fast enough to safely get past the point of collision before B would reach it, then it can execute.

In many cases, there will be many items of tableware that need to be picked up and loaded into a dish rack. In one embodiment, the system uses its cameras to identify tableware on top of a pile of tableware, find all possible grasps on all available items of tableware and for each such item rank the item based on ability to pick up without a collision, how much room for error exists when picking up the item, and if the finger attachment needed to pick up the item is current installed on the robotic arm. The system will choose the highest ranked item to grasp next (but if two items are tied then choose one randomly).

In one embodiment, to safely and securely grasp tableware each robotic arm 12 and 14 includes a parallel axis gripper 602 connected to the end effector of the arm. Finger attachments connect to the gripper for grasping tableware. The gripper controls the finger attachments. In one set of embodiments, the finger attachments are detachable so that the system can have different type of finger attachments for different applications, as explained below.

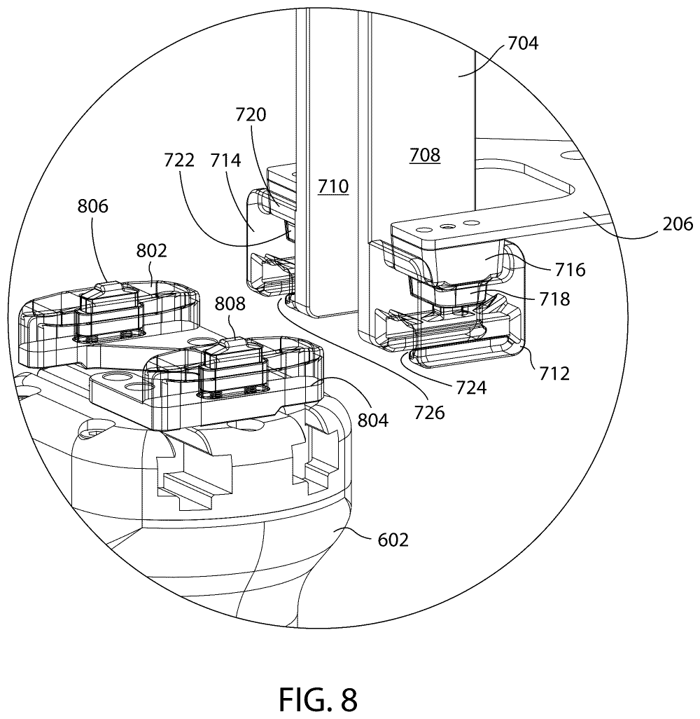

More details of gripper 602 are provided in FIG. 8. Gripper 602 includes two rails 802 and 804 and two latches 806 and 808. Gripper 602 includes an electric motor (not depicted in the drawings), connected to control circuit 244 and rails 802 and 804, for causing rails 802 and 804 to move toward each other and away from each other in response to control circuit 244. Latches 806 and 808 removably lock finger attachments to the gripper 602 such that rails 802 and 804 engage the finger attachments to manipulate the finger attachments.

In order to properly grasp different types of tableware, it is necessary to use multiple different gripper and finger attachment geometries. For example, some types of plates that are stacked on top of one another are difficult to grasp from one edge, because there may only be a very small amount of space between the edge of each plate in the stack, and this space may be less than the thickness of a finger attachment. Therefore, it may be impossible to perform a “pinch grasp” on the edge of the top plate, because one of the finger attachments may not fit between the top plate and the plate underneath it. One approach to handling stacked plates is to perform an “encompassing grasp,” where the finger attachments separate widely enough to surround the entire plate and grasp it on two opposite edges. For example, on a circular plate, the points of contact between the finger attachments and the plate are centered at two diametrically opposite points on the edge of the plate.

Another challenge when grasping tableware using an “encompassing grasp” is that different dish sizes require different distances between the fingers. A typical 2-finger parallel electric robotic gripper may have a stroke of 5 cm, which is the maximum distance that the fingers can travel. But the diameter of a circular dinner plate may be 27 cm, and the diameter of a salad plate may be 15 cm. To encompass this range of diameters, either separate finger attachments with different encompassing widths must be used, or a mechanism to magnify the stroke of the gripper must be used. To magnify the stroke of the gripper, a “scissor” mechanism may be used, where the pivot point is closer to the gripper than it is to the fingertips.

Other types of tableware may require different grasping methods. For example, cylindrical drinking glasses may be grasped along the rim using a “pinch grasp” with a finger separation equal to the thickness of the glass (typically less than 1 cm). Additionally, cylindrical drinking glasses may be grasped from the side or bottom using an “encompassing grasp.” In order to accomplish these grasps, different finger geometries may be necessary. For example, a typical 2-finger parallel electric robotic gripper may have a stroke of 5 cm. But the glass may have a diameter that exceeds 5 cm. To achieve these grasps that require such a range of distances between the fingers, either separate fingers of different widths must be used, or a mechanism to magnify the stroke of the gripper must be used. Thus, it is proposed to use multiple, different finger attachments that can each be removably attached to and detached from gripper 602.

In order to utilize different finger attachments for different grasps, it is necessary for the robotic arms to attach and detach finger attachments as necessary, based upon the task, dish type, and desired grasp. To accomplish this, a mechanism is used to attach and detach the finger attachments that is tolerant to small misalignments of the arms.

It is also necessary that the finger attachments be waterproof and dishwasher-safe, so that they can be periodically cleaned and sanitized. To accomplish this, the finger attachments should not contain electrical components, and should not depend on adhesives or other materials that can degrade when subjected to heat or moisture. For example, the finger attachments may utilize silicone overmolding that interfaces with geometries that hold it in place, avoiding the need for adhesives. The finger attachments should not contain cracks or geometrical features that can easily trap food debris.

Multiple sets of finger attachments may be stored in holders, referred to as holster mounts, positioned so that they are reachable by the robotic arms but do not obstruct the workspace. Holster mounts 206 are depicted in FIGS. 1-5 and 8. The dish racks may contain additional finger attachment holders. To clean and sanitize its finger attachments, a robotic arm may detach its finger attachments into a holder within a dish rack, and then push the dish rack into the dishwasher and operate it normally. Once the dishwasher's wash cycle has completed, the robotic arm removes the cleaned finger attachments from the dish rack.

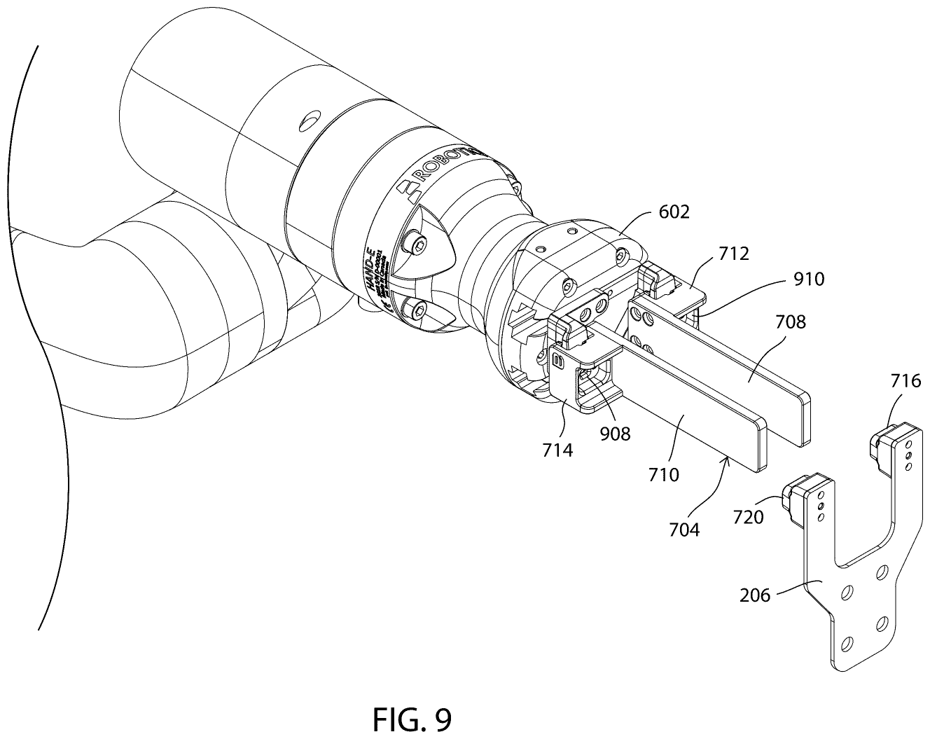

FIG. 8 depicts a portion (i.e., proximal end) of one example of a finger attachment 704 mounted in holster mount 206. Finger attachment 704 includes finger tips 708 and 710. Finger tip 718 is connected to carriage 712. Finger tip 710 is connected to carriage 714. Carriage 712 includes a magnet 718 for interfacing with magnet 716 of holster mount 206. Carriage 714 includes a magnet 722 for interfacing with magnet 720 of holster mount 206. Magnets 716, 718, 720 and 722 hold finger attachment 704 to holster mount 206. Gripper 602 connects to finger attachment 704 by sliding rail 806 into groove 726 of carriage 714 and sliding rail 808 into groove 724 of carriage 712 until latches 806 and 808 engage depressions in grooves 724/726 and lock the rails in place. Robotic arms 12 and 14 can apply sufficient force to pull finger attachment 704 away from holster mount 206 (overcome force of the magnets) by gripper 602 sliding rail 806 into groove 726 of carriage 714 and sliding rail 808 into groove 724 of carriage 712, and then pulling gripper 602 away from holster mount 206. FIG. 9 depicts finger attachment 704 after being connected to gripper 602 and being removed from holster mount 206.

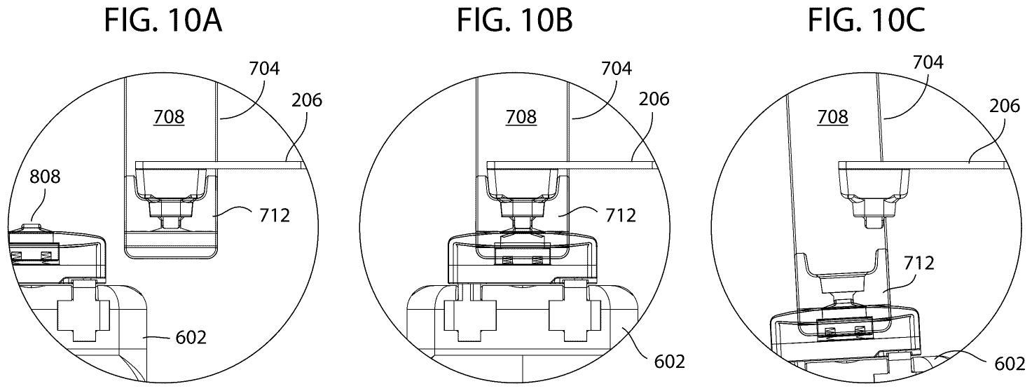

FIGS. 10A-C provide a close-up view of gripper 602 connecting to finger attachment 704 and removing finger attachment 704 from holster mount 206. FIG. 10A depicts finger attachment 704 connected to holster mount 206 via the magnets, as discussed above. FIG. 10B depicts gripper 602 connected to finger attachment 704 after rail 806 was slid into groove 726 of carriage 714 and rail 808 was slid into groove 724 of carriage 712 until latches 806 and 808 engaged depressions in grooves 724/726 and locked the rails in place. FIG. 10C depicts holster mount 206 separated from finger attachment 704 after the robotic arm pulled down on gripper 602 to separate finger attachment 704 from holster mount 206.

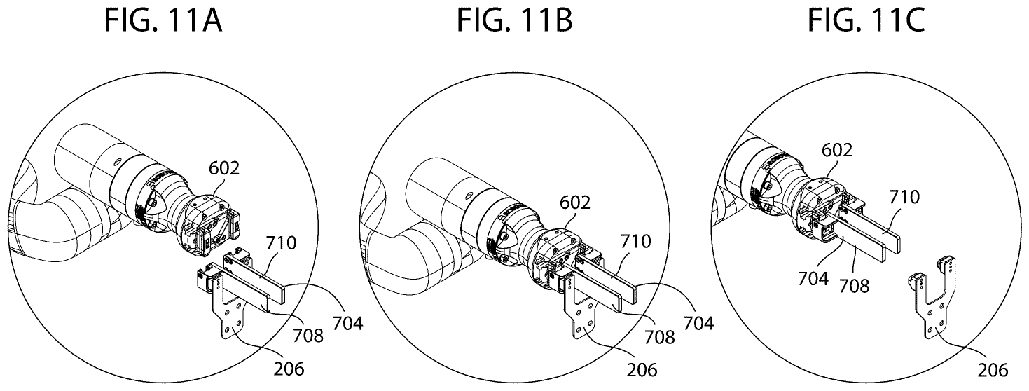

FIGS. 11A-C depicts a macro view of gripper 602 connecting to finger attachment 704 and removing finger attachment 704 from holster mount 206. FIG. 11A depicts finger attachment 704 connected to holster mount 206 via the magnets, as discussed above. FIG. 11B depicts gripper 602 connected to finger attachment 704 after rail 806 was slid into groove 726 of carriage 714 and rail 808 was slid into groove 724 of carriage 712 until latches 806 and 808 engaged depressions in grooves 724/726 and locked the rails in place. FIG. 11C depicts holster mount 206 separated from finger attachment 704 after the robotic arm pulled down on gripper 602 to separate finger attachment 704 from holster mount 206.

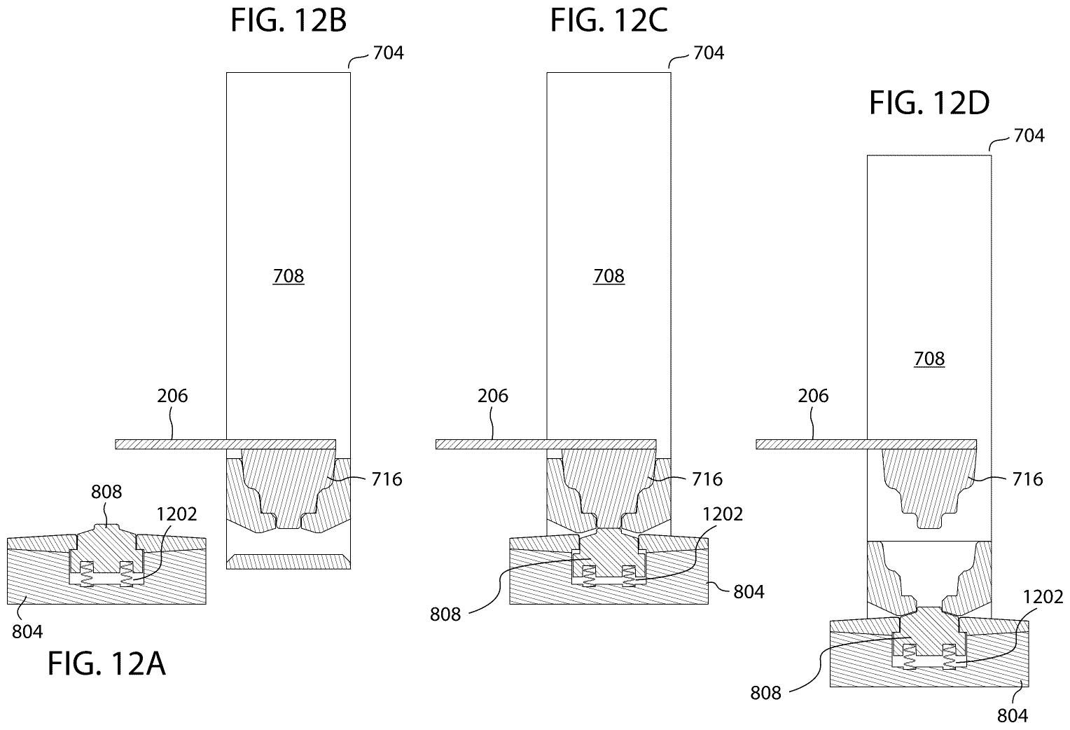

FIGS. 12A-D depicts a cutaway view of rail 804 of gripper 602 connecting to finger attachment 704 and removing finger attachment 704 from holster mount 206. FIG. 12A is a cutaway view of rail 804, depicting latch 808 being biased by spring 1202. FIG. 12B depicts finger attachment 704 connected to holster mount 206 via the magnets, as discussed above. FIG. 12C depicts latch 808 engaging finger attachment 704 such that latch 808 is depressed into rail 808 causing compression of spring 1202. FIG. 12D depicts holster mount 206 separated from finger attachment 704 after the robotic arm pulled down on gripper 602 to separate finger attachment 704 from holster mount 206. FIG. 12D depicts rail 804 connected to finger attachment 704, with spring 1202 no longer compressed.

Prior to operation of the robotic systems described herein, a set-up process is performed. In one embodiment, a three dimensional (3D) scan of all tableware is performed including taking many photographs from different angles to create a 3D model for each type of tableware. In another embodiment, a three dimensional (3D) scan of all tableware is performed using a laser 3D scanner device. The 3D model describes the structure of the item of tableware. Key points are then identified on the 3D model, for use by a neural network trained to detect such key points. For each 3D model, grasps are determined that include the finger attachments to use and the pose of the finger attachments for grabbing/grasping the item of tableware. Thus, for each type of tableware, there are three files created: 3D model, identification of key points on the 3D model, and grasps (text file). Each 3D model has its own coordinate system and includes a six degree of freedom pose (6DOF) comprising three x, y and z translations from an origin and three degrees of rotation (e.g., roll, pitch and yaw). In another embodiment, each model is created by taking many photos of the tableware and providing those photos to a neural network. In another embodiment, depth cameras are used to create each model of tableware by using the data from the depth cameras to create a point cloud.

FIG. 13 depicts examples of tableware, including glass 1302, cup 1304, mug 1306, spoon 1308, bowl 1310 and plate 1312. Prior to operation, three files are created for each item of tableware: (1) a three dimensional model of the item, (2) identification of key points and (3) identification of potential grasps. The key points are locations on each item that are visually distinctive, such that a neural network can recognize them. Each item is likely to have many key points. FIG. 13 shows examples of key point for each item of tableware 1302-1310 as a dashed circles 1320, 1322, 1324, 1326, 1328, 1330 and 1332.

FIGS. 7-12D depict one example of a finger attachment connected to gripper 602 that is referred to as parallel fingers (e.g., parallel finger tips 708 and 710). As rails 802 and 804 move toward each other and away from each other in response to a motor controlled by control circuit 244, finger tips 708 and 710 are caused to move toward each other and away from each in order to perform tasks, including grabbing or manipulating objects (including tableware) as well as interfacing with other structures (e.g., dishwasher, racks, etc.).

In general, the finger attachments include two moveable fingers and connect to the two rails of the gripper. Moving the rails of the gripper toward and away from each other causes the fingers to be operated (e.g., moving away or toward each other, opening and closing, etc.).

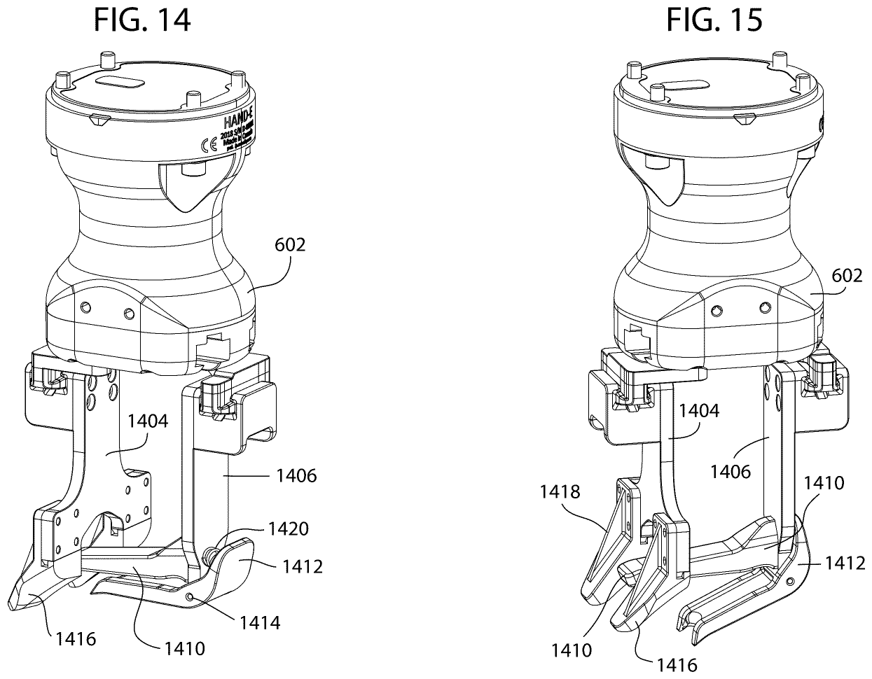

FIGS. 14-19 depict another example of a finger attachment, referred to as the plate bite fingers. The plate bite fingers include support 1404 and support 1406, each of which are connectable and detachable from one of the rails 802/804 of gripper 602. A tongue 1412 is attached to the bottom of support 1406 at a pivot 1414. A bridge 1410 is rigidly connected to the bottom of support 1406. A spring 1420, attached to support 1406 and tongue 1412, biases tongue 1412 to press against the bottom of bridge 1410. At the bottom of support 1404 are two paws 1416 and 1418. In one embodiment, paws 1416 and 1418 are hard plastic that is lined with soft silicone having grooves (e.g., treads like a tire). In one example, bridge 1410 contacts the edge of a plate first, the paws contact the top of the plate and the tongue 1412 opens (via pivot 1414) only to the necessary amount (due to spring 1420) in order to contact and support the bottom of the plate.

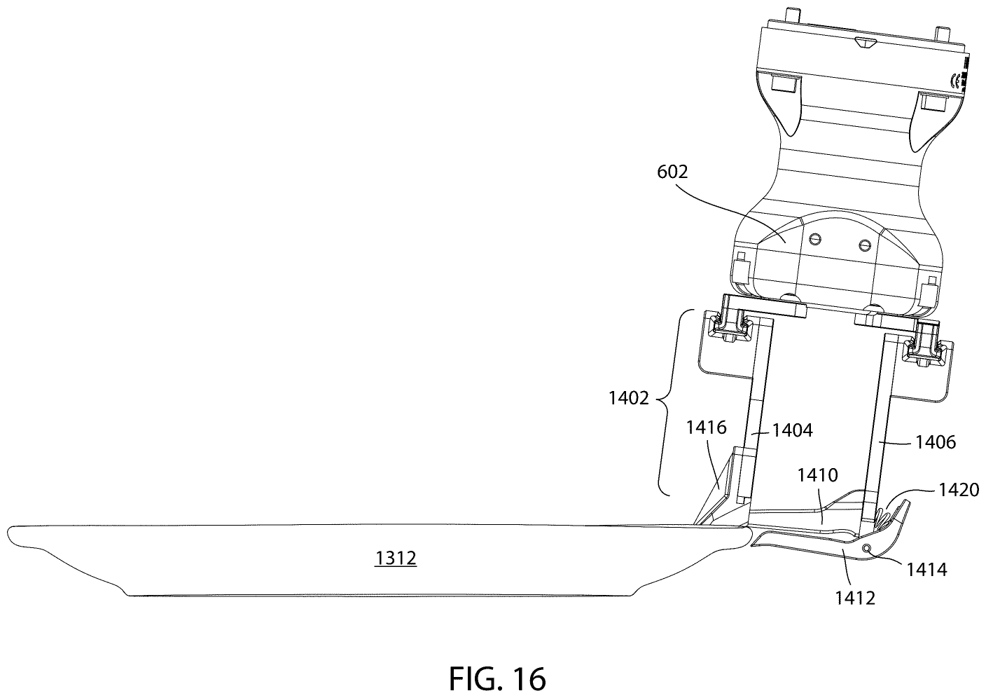

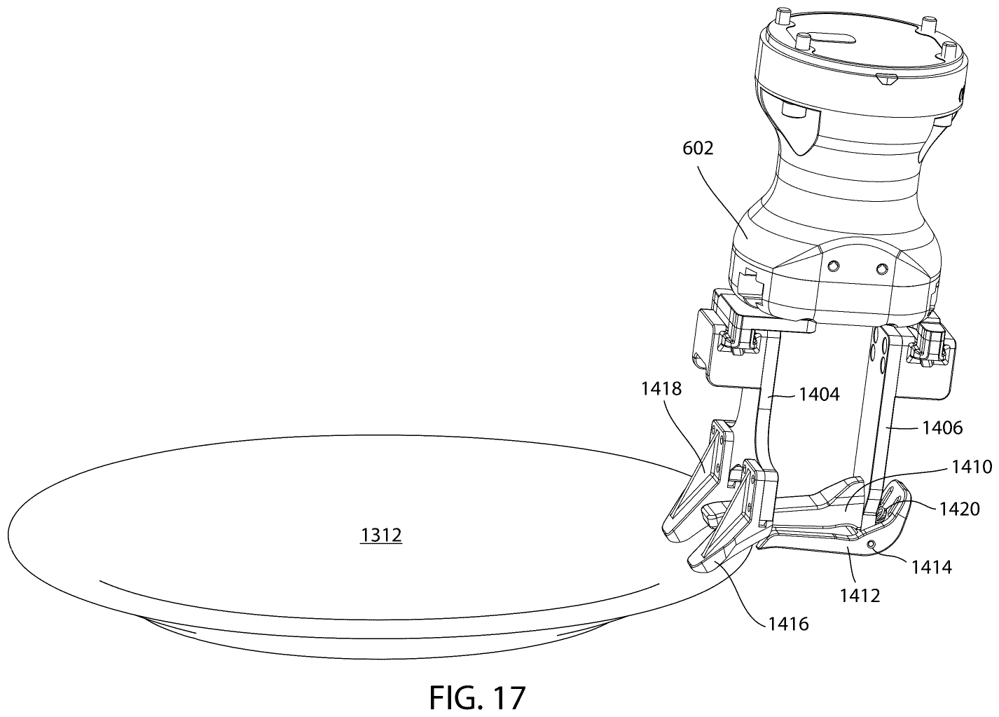

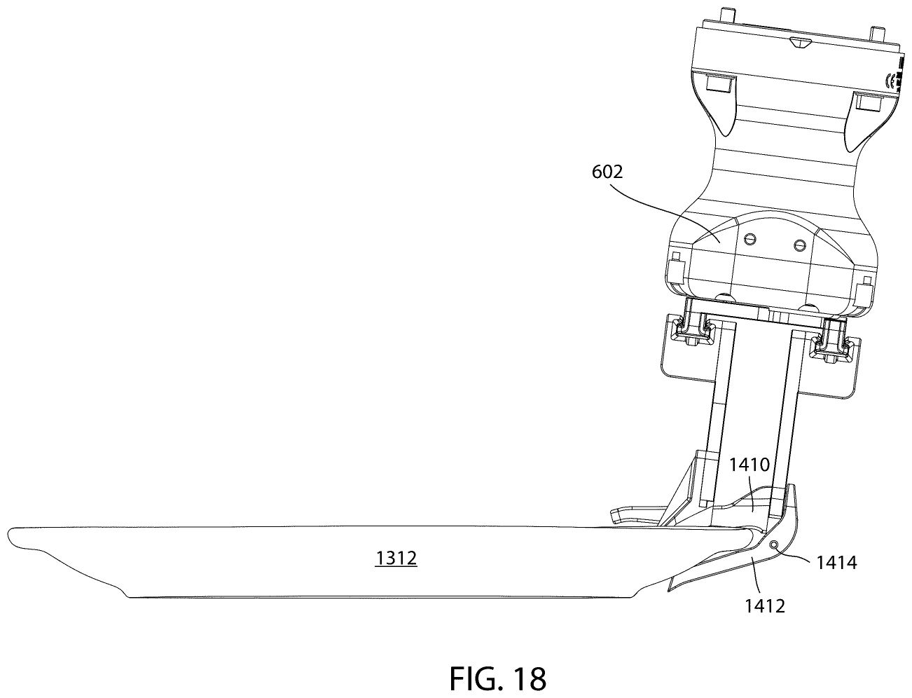

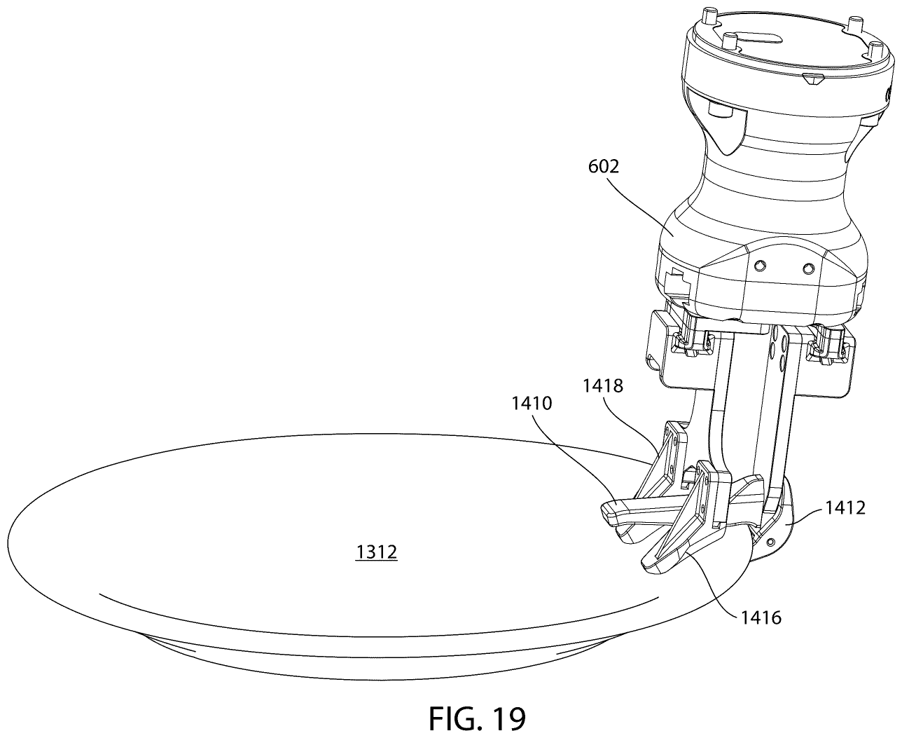

FIGS. 16-19 depict the plate bite fingers grabbing a plate. To grab a plate using the plate bite fingers of FIGS. 14 and 15, the robotic arms touches down the bridge 1410 of the plate bite fingers on the top of the rim of plate 1312 and paws 1416/1418 are also positioned on the top of plate 1312, as depicted by FIGS. 16 and 17. Subsequently, tongue 1412 is shoved under plate 1312 toward the center of plate 1312 while moving rails 802 and 804 of gripper 602 toward each other, causing paws 1416/1418 to pinch the plate against tongue 1412 and bridge 1410; thereby grabbing and holding the plate as depicted in FIGS. 18 and 19.

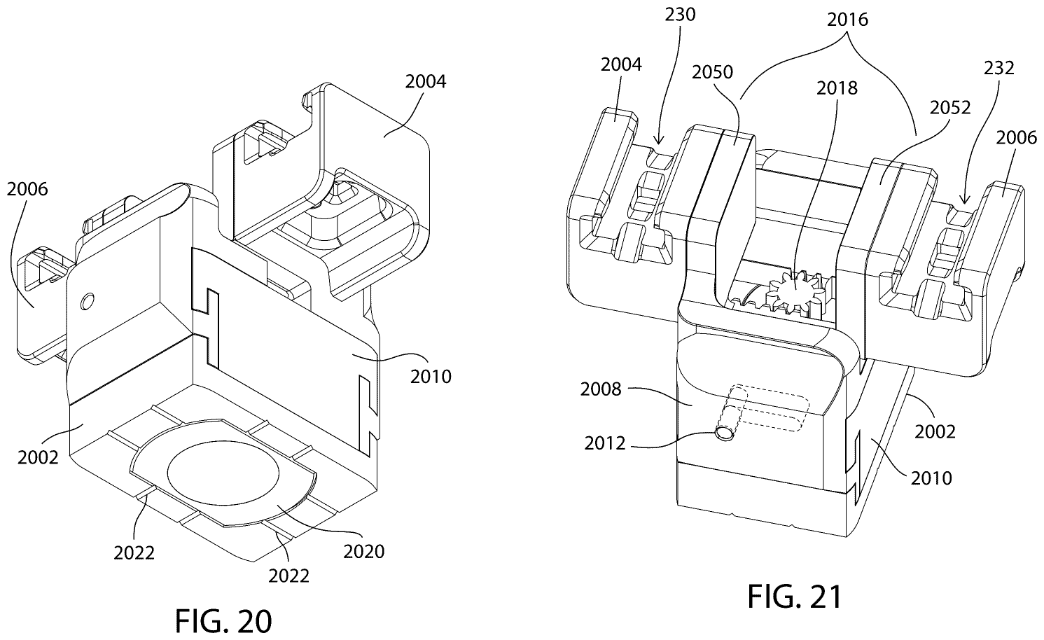

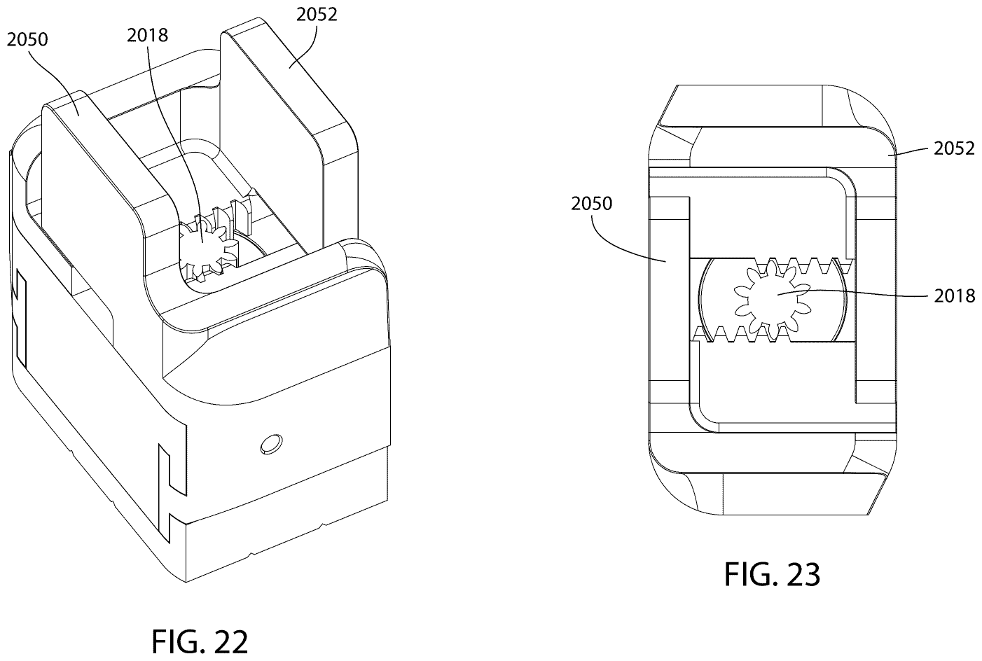

FIGS. 20-27 depict another example of a finger attachment, referred to as the magnetic finger attachment, as it uses magnets to hold tableware. Magnetic finger attachment 2002 includes two wings 2004 and 2006 connected by a rack and pinion mechanism 2016. Wing 2004 is attached to fin 2050 of rack and pinion mechanism 2016. Wing 2006 is attached to fin 2052 of rack and pinion mechanism 2016. Fins 2050 and 2052 move in relation to each other (e.g., toward and away from each other) causing rotation of center screw 2018. FIGS. 22 and 23 provide a top view of rack and pinion mechanism 2016.

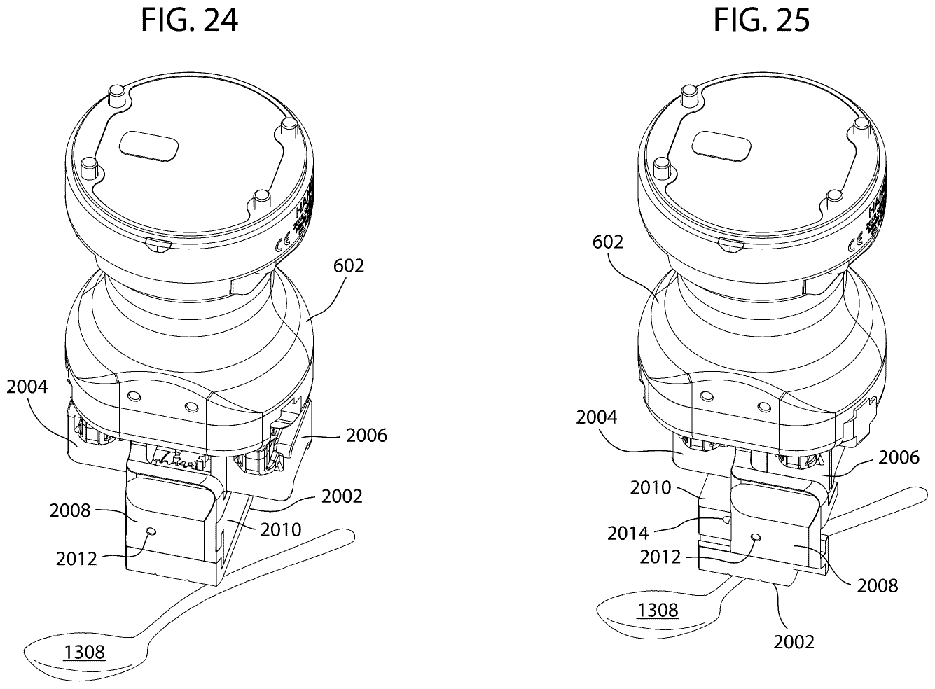

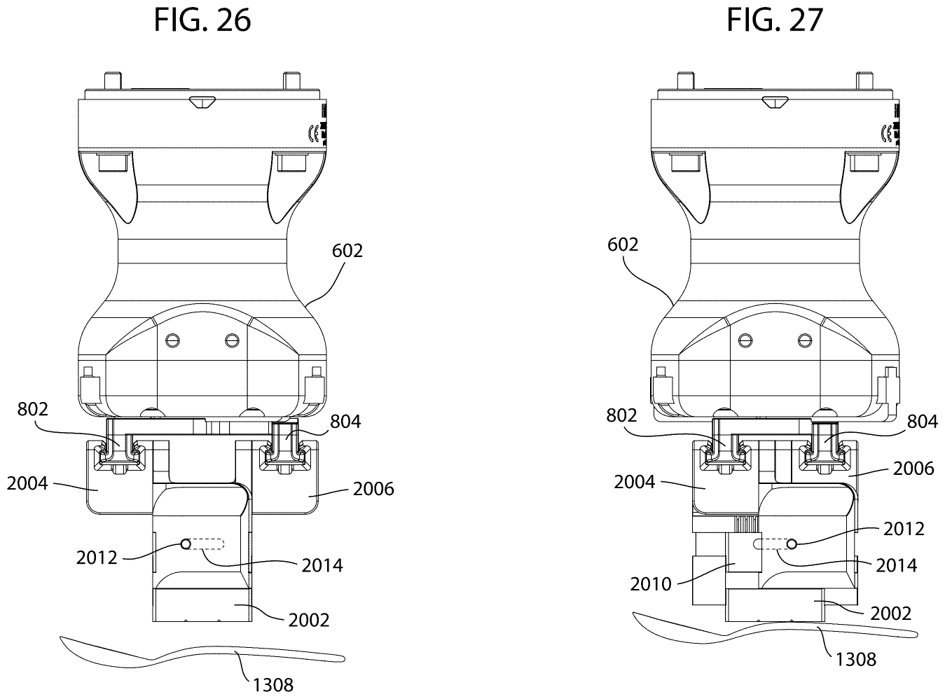

Wing 2004 includes a groove 230 for receiving rail 802 and wing 2006 includes a groove 232 for receiving rail 804 (as discussed above with respect to FIGS. 8-12D). As gripper 602 moves rails 802 and 804 towards and away from each other, wings 2004 and 2006 are caused to be similarly moved towards and away from each other, which causes fins 2050 and 2052 to be similarly moved towards and away from each other. A stopping pin 2012 prevents over stroke. Inside body 2010 of magnetic finger attachment 2002 is an on/off switch magnet 2020 connected to wings 2004 and 2006. The on/off switch magnet 2020 is a magnet with a rotatable switch. In one position of the switch, the magnet is off. Rotating the switch to a second position turns on the magnet so that the magnet has a pull force. In one embodiment, on/off switch magnet 2020 includes multiple internal magnets so that when screw 2018 is turned, the magnets can align (magnet off) or become unaligned (magnet on). An alternate embodiment is to use an electromagnet. The switch of the on/off switch magnet 2020 is connected to the center screw 2018 of rack and pinion mechanism 2016 so that as the center screw turns in one direction (e.g., due to wings 2004 and 2006 moving toward each other) the switch turns on the magnet 2020 as depicted in FIGS. 25 and 27 (spoon 1308 held against magnetic finger attachment 2002) and as the center screw turns in a second direction (e.g., due to wings 2004 and 2006 moving away from each other) the switch turns off the magnet 2020 as depicted in FIGS. 24 and 26 (spoon 1308 not held against magnetic finger attachment 2002). Note that the bottom surface of body 2020 includes channels 2022 for food debris.

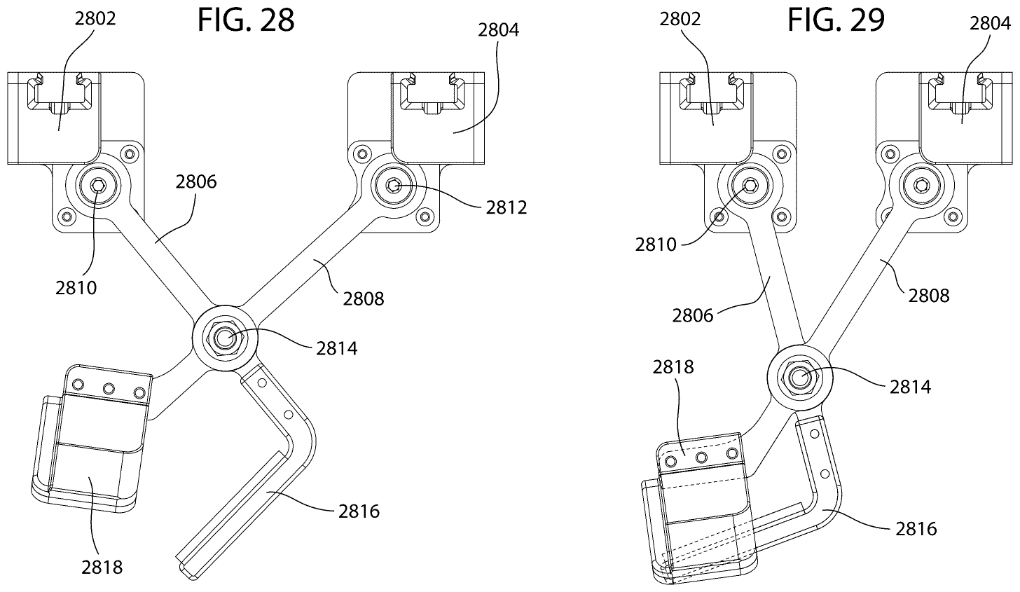

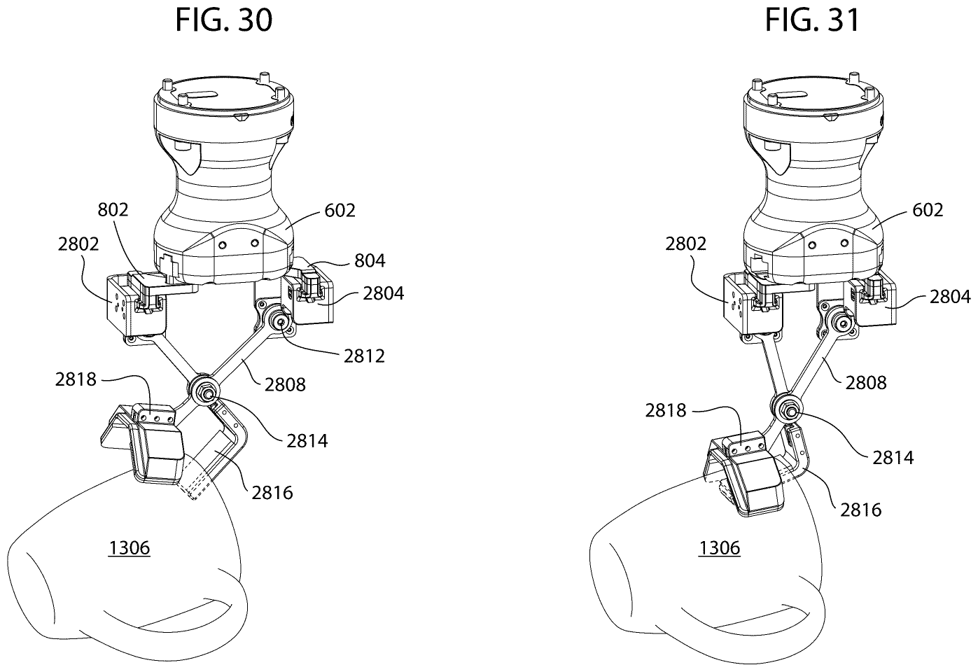

FIGS. 28-31 depict another example of a finger attachment, referred to as the plier fingers. In one embodiment, the plier fingers includes wing 2802 for connecting to rail 802 of gripper 602 and wing 2804 for connecting to rail 804 of gripper 602. Connected to wing 2802 at pivot 2810 is stainless steel bar 2806. Connected to wing 2804 at pivot 2812 is stainless steel bar 2808. Bar 2806 and bar 2808 both connect to pivot 2814. Also connected to pivot 2814 are tongue 2816 and arched surface 2818. As the gripper 602 moves rails 802 and 804 toward each other and away from each other, bars 2806 and 2808 pivot toward each other and away from each other. When bars 2806 and 2808 pivot toward each other, tongue 2816 moves toward arched surface 2818 to grab an item of tableware. When bars 2806 and 2808 pivot away from each other, tongue 2816 moves away from arched surface 2818 to let go of an item of tableware. This movement is illustrated by FIGS. 30 and 31, as FIG. 30 depicts tongue 2816 moving toward arched surface 2818 such that tongue 2816 is underneath the lip of mug 1306. FIG. 31 depicts the plier fingers holding mug 1306 such that tongue 2816 is underneath and pressed up against the lip of mug 1306 toward arched surface 2818 and arched surface 2818 is on top of and pressed up against the lip of mug 1306 toward tongue 2816. In one embodiment, bar 2806 is rigidly connected to tongue 2816 forming a first finger and bar 2808 is rigidly connected to arched surface 2818 forming a second finger, with the two fingers pivoting about pivot point 2814 to provide a scissor action.

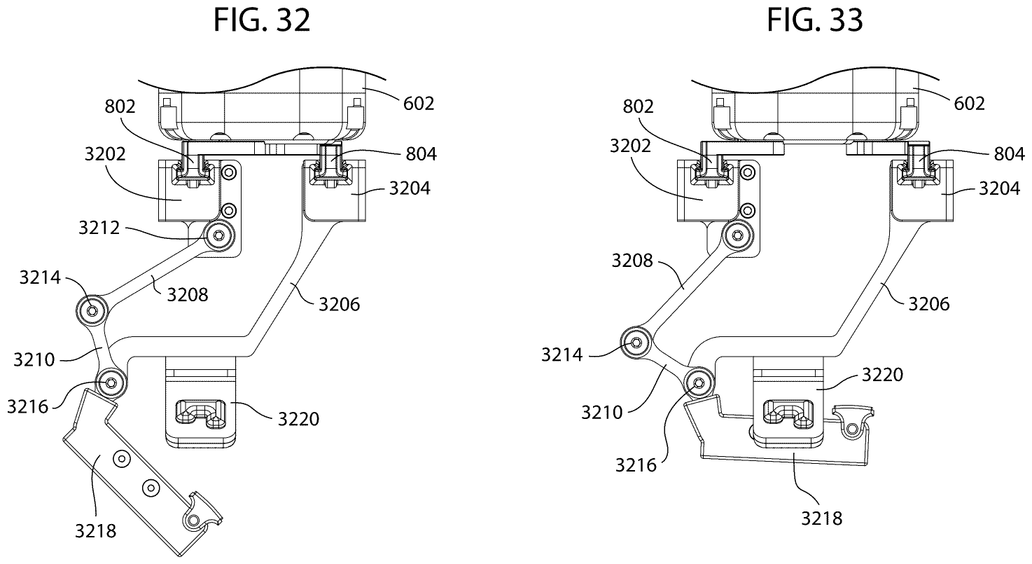

FIGS. 32-35 depict another example of a finger attachment, referred to as the alligator fingers, which includes two fingers attached at a pivot and further includes two additional pivot points. The alligator fingers include wing 3202 for connecting to rail 802 of gripper 602 and wing 3204 for connecting to rail 804 of gripper 602. Connected to wing 3202 at pivot 3212 is stainless steel bar 3208. Connected to bar 3208 at pivot 3214 is stainless steel bar 3210. Rigidly connected to bar 3210 is lower jaw 3218. Rigidly connected to wing 3204 is stainless steel bar 3206. Bar 3206 is also connected to bar 3210 at pivot 3216. Rigidly connected to bar 3206 is an upper jaw 3220. In one embodiment, upper jaw 3220 is an arched surface with silicone on its outer surface and lower jaw 3218 is a flat surface with silicone on its outer surface.

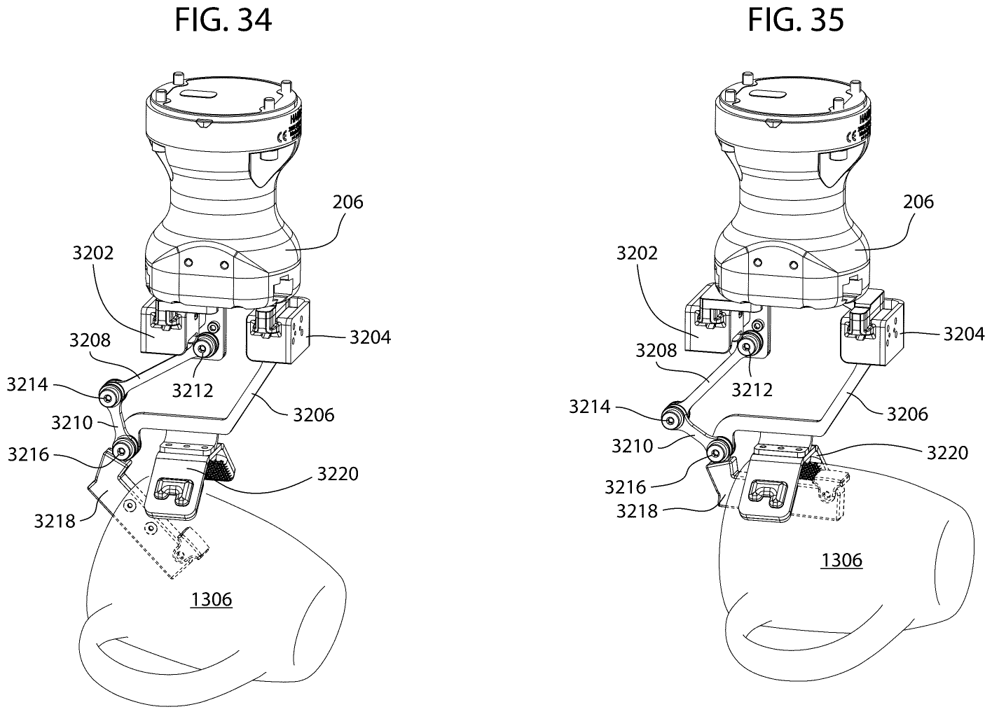

As the gripper 602 moves rails 802 and 804 toward each other and away from each other, bars 3206 and 3208 pivot toward each other and away from each other. When bars 3206 and 3208 pivot toward each other, bar 3210 is caused to pivot clockwise and open lower jaw 3218, as depicted in FIG. 32. When bars 3206 and 3208 pivot away from each other, bar 3210 is caused to pivot counterclockwise and close lower jaw 3218 with upper jaw 3220 in order to hold tableware, as depicted in FIG. 33. FIG. 34 shows the alligator fingers approaching mug 1306 from the side and FIG. 35 shows the alligator fingers securely holding mug 1306.

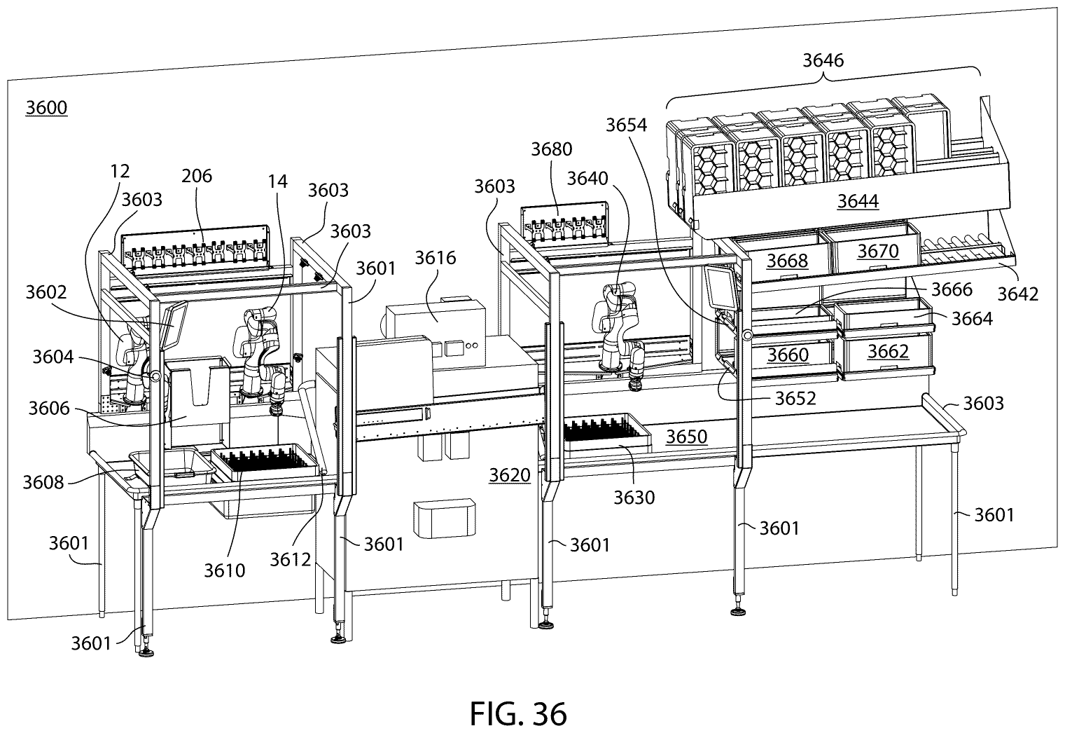

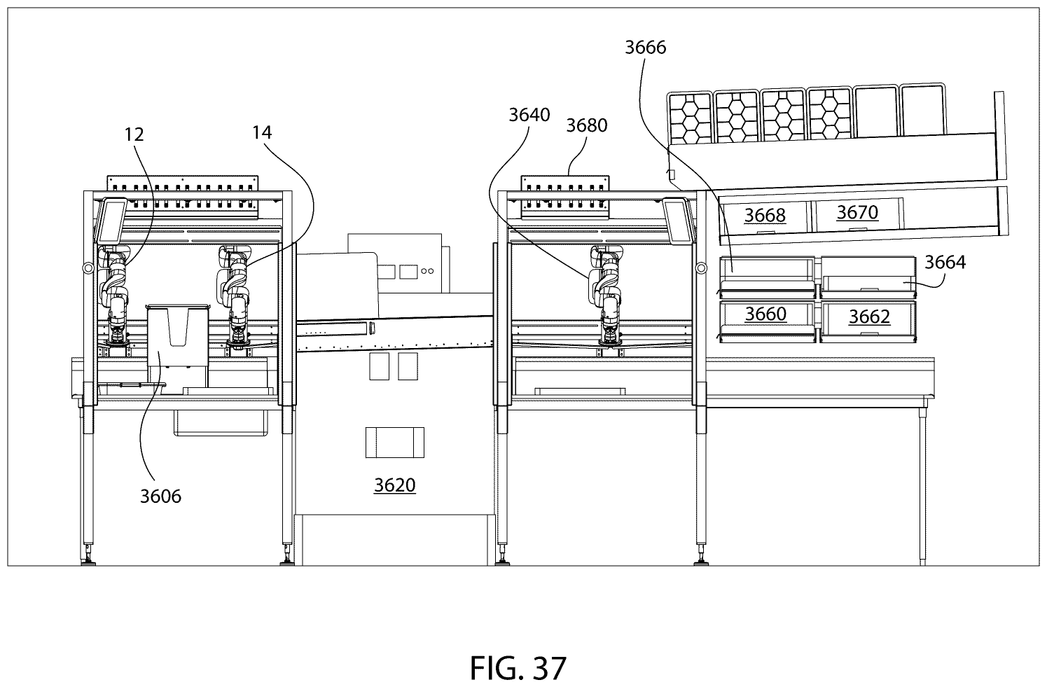

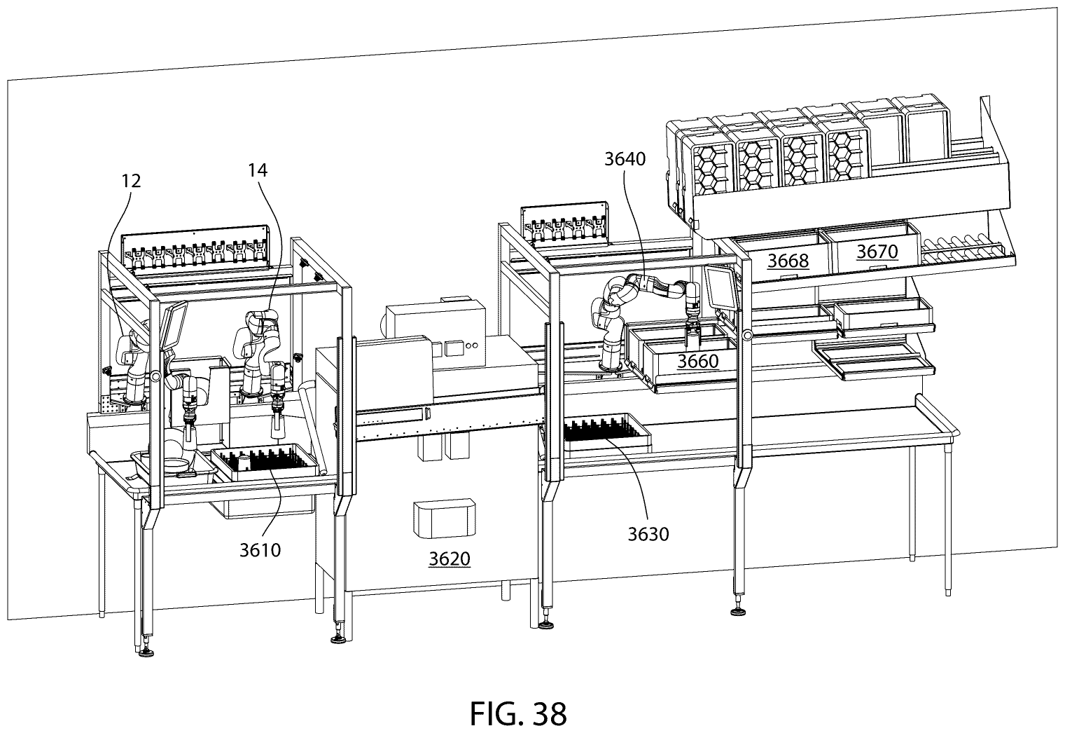

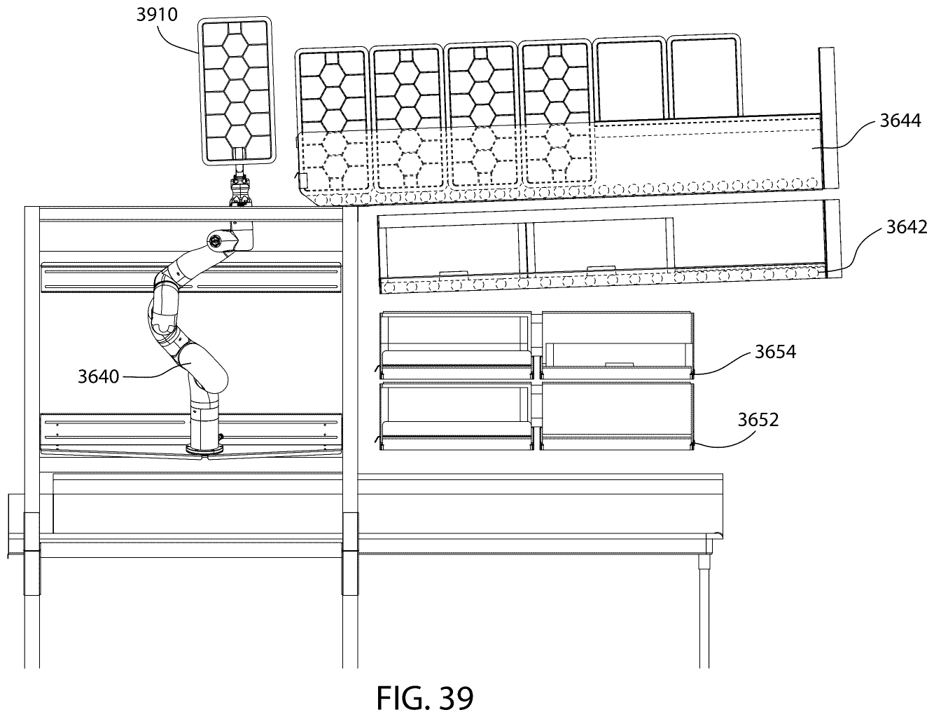

FIGS. 1-5 depict an embodiment with two robotic arms 12 and 14 near the dishwasher 20 for loading dirty tableware into the dishwasher, with one or both of those two robotic arms also unloading clean tableware form the dishwasher. FIGS. 36-42 describe additional embodiments that include arms 12 and 14 on the dirty side of the dishwasher for loading dirty tableware into the dishwasher, and further include a third robotic arm 3640 on the clean side of the dishwasher for unloading clean dishes that were washed by the dishwasher. The robotic apparatus for arranging tableware that is depicted in FIG. 36 includes a support structure comprising vertical poles 3601 and horizontal rails 3603. Robotic arms 12 and 14 are mounted on rails 3603, on the dirty side of dishwasher 3620. Holster mounts 206 (above the robotic arms) for holding finger attachments for robotic arms 12 and 14 are also mounted on rails 3603. A touch panel 3602 is provided that allows the operator to control the depicted system (e.g., manual override). A waste bin 3606 is provided for scraping or otherwise removing food from dirty tableware. In one embodiment, waste bin 3606 is a rinse container that includes six nozzles to spray water on tableware to clean off debris into the rinse container (in one embodiment one robotic arm puts tableware into the rinse container and another robotic arm removes the tableware from the rinse container). The dirty tableware is provided to the robotic arms 12 and 14 in bus tub 3608. As explained herein, robotic arms will work together to load dirty tableware from bus tub 3608 into dish rack 3610. Once loaded with dirty tableware, dish rack 3610 is inserted into dishwasher 3620 and robotic arm 14 will operate dishwasher 3620 to start a wash cycle. One of the robotic arms can open dishwasher 3620 by grabbing and moving dishwasher door handle 3612.

A control circuit 3616 (e.g., one or more computers, processors, controllers) is connected to (and in communication with) the robotic arms 12, 14 and 3640, as wells the various cameras, touch panel 3602 and any other sensors. The system also includes a set of light curtains and cameras, as explained above with respect to FIGS. 1-6. The system also includes emergency stop buttons 3604 and 3654 connected to control circuit 3616 for forcing the system to immediately shut down. In one embodiment, the cameras include twenty cameras spread out in the structure so that every part of the structure depicted in FIG. 36 is within the field of view of at least one camera. In one example implementation, there are sixteen RGB cameras (5 of which are focused on the dirty racks and 5 of which are focused on the clean racks), two depth cameras on the dirty side, and one depth camera on the clean side.

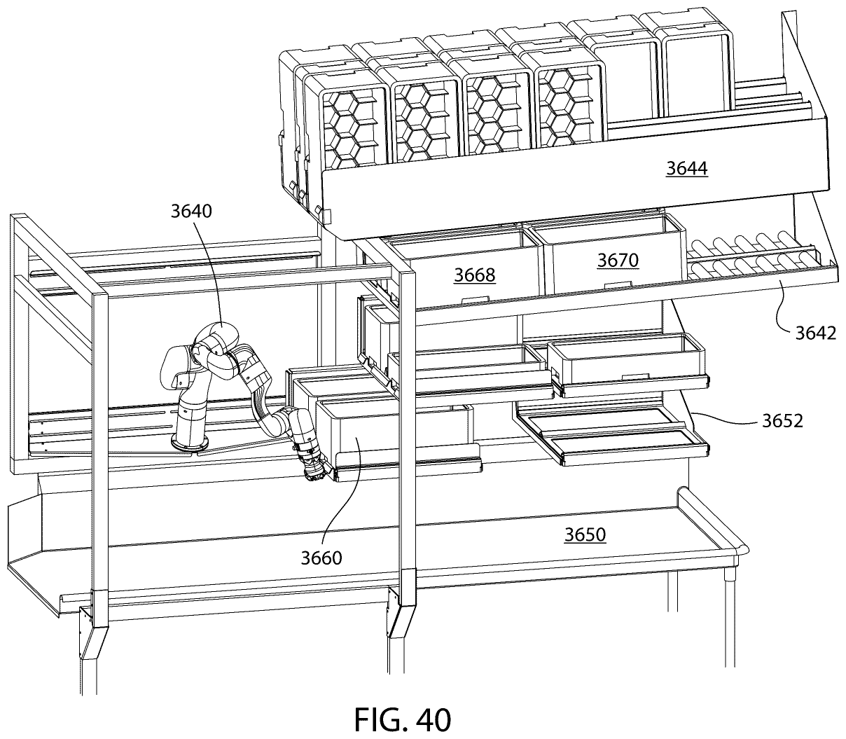

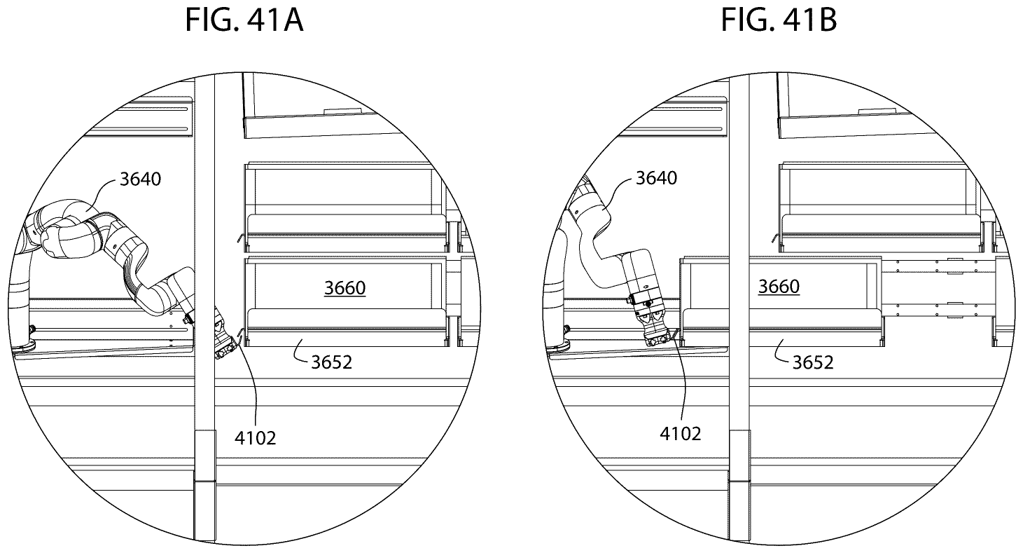

After dishwasher 3620 completes the wash cycle for the tableware, a dish rack 3630 is output to bottom surface 3650 on the clean side of dishwasher 3620 so that robotic arm 3640 can unload the clean tableware into storage racks 3660, 3662, 3664, and 3666, as well as unloading clean tableware onto surface 3650. In one embodiment, there are different storage racks for different types of tableware and different levels of rack shelves (e.g., rollers, shelves and/or other structures) for different types of storage racks. For example, a first shelf 3652 supports storage racks 3660 and 3662, and a second shelf 3654 supports storage racks 3664 and 3666. Robotic arm 3640 can load a first set of one or more types of tableware to storage racks 3660 and 3662 and a second set of one or more types of tableware to storage racks 3664 and 3666. Empty rack storage 3644 is used to store clean, empty storage racks such that when one of shelves 3652 or 3654 has free space, then robotic arm 3640 can move a storage rack (e.g., storage rack 3910) from empty rack storage 3644 to the shelf with open space, as depicted in FIG. 39. FIG. 40 show robotic arm 3640 moving the storage rack 3660 into position on shelf 3652. FIGS. 41A and 41B show more details of robotic arm 3640 moving storage rack 3660 by pushing or pulling drawer handle 4102 on shelf 3652. As can be seen from FIG. 40, shelves 3652 and 3654 are multiple storage racks deep, allowing for many different types (or the same type) of storage racks to be accessed at the same time.

In one embodiment, robotic arm 3640 is of the exact same structure as robotic arms 12 and 14, including a gripper 602 that can use interchangeable finger attachments (which are stored on holster mounts 3680 above robotic arm 3640). Holster mounts 3680 are mounted on rails 3603 and are the exact same structure as holster mounts 206.

In one embodiment, the operational flow on the clean side comprises a human operator putting empty storage racks on rack return 3642. Robotic arm 3640 (when it has free time—e.g., idle) grasps a rack from rack return 3642 and figures out what type of rack it is using one or more cameras and image recognition, and places the storage rack on the appropriate shelf (of shelves 3652 and 3654) or into the appropriate row of empty rack storage 3644. Robotic arm 3640 then takes clean tableware from rack 3630 and puts it in the appropriate storage rack (e.g. of storage racks 3660, 3662, 3664 and 3666). In one embodiment, plates are loaded on surface 3650 rather than in a storage rack. Once a storage rack is full of clean tableware, it is pushed in the direction away from robotic arm 3640, and the arm places a new empty rack on the shelf.

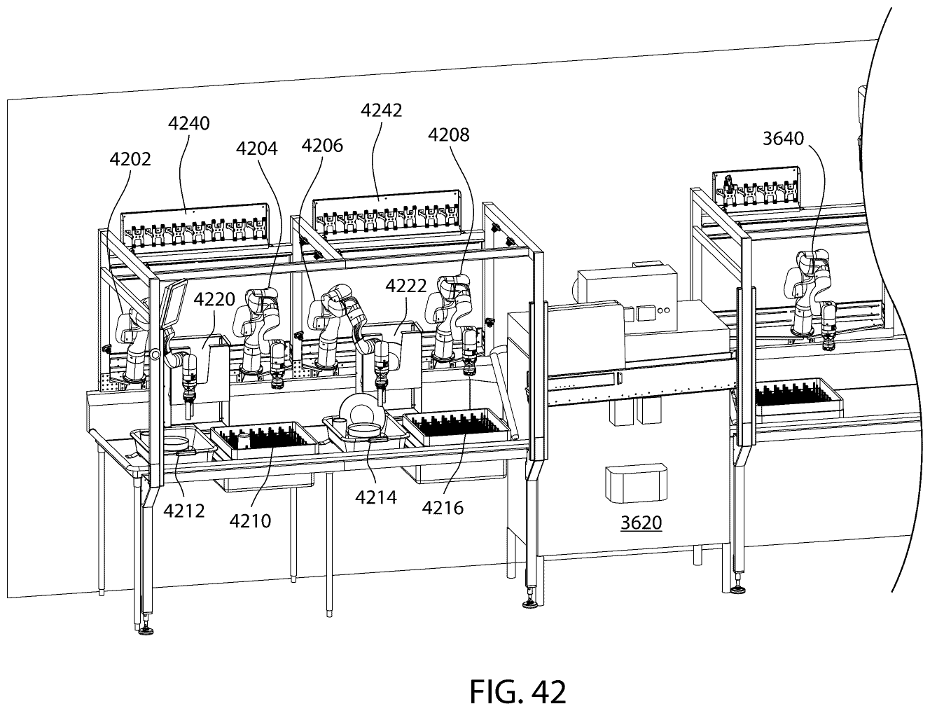

FIG. 42 depicts an embodiment that includes two pairs of robotic arms on the dirty side of dishwasher 3620, with one robotic arm 3640 on the clean side. In other embodiments, there can be two or more robotic arms on the clean side. The two pairs of robotic arms on the dirty side of dishwasher 3620 include a first pair of robotic arms 4202 and 4204, and a second pair of robotic arms 4206 and 4208. Robotic arms 4202, 4204, 4206 and 4208 are of the same structure as robotic arms 12 and 14. Robotic arms 4202 and 4204 use interchangeable finger attachments that are stored on holster mounts 4240 to pick dirty tableware from bus tub 4212, rinse off the dirty tableware using rinse container 4220 and place the rinsed dirty tableware in dish rack 4210. Robotic arms 4206 and 4208 use interchangeable finger attachments that are stored on holster mounts 4242 to pick dirty tableware from bus tub 4214, rinse off the dirty tableware using rinse container 4222 and place the rinsed dirty tableware in dish rack 4216.

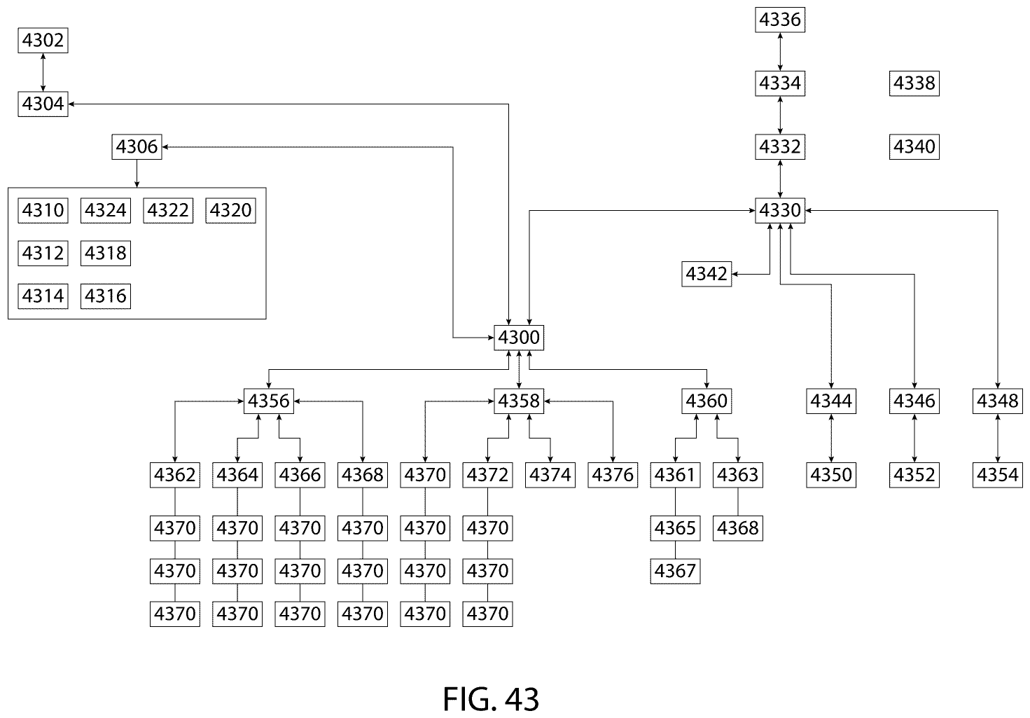

FIG. 43 is a block diagram of the electrical components of one embodiment of the robotic apparatus for arranging tableware described above with respect to FIGS. 1-42. The system of FIG. 43 includes main computer 4330 connected to communication interface 4334 (with the ability to communicate via Ethernet or cellular), Ethernet relay controller 4342, and arm controllers 4344/4346/4348. Communication interface 4334 is connected to Ethernet interface 4336. Arm controller 4344 connects to and controls arm electronics 4350 for robotic arm 12. Arm controller 4346 connects to and control arm electronics 4352 for robotic arm 14. Arm controller 4348 connects to and controls arm electronics 4354 for robotic arm 3640. Main computer 4330 is also connected to controller 4300 or operating and communicating with the cameras and user interface. For example, controller 4300 is connected to USB interfaces 4356, 4358 and 4360. USB interface 4356 is connected USB hubs 4362, 4364, 4366 and 4368. USB interface 4358 is connected USB hubs 4370, 4372, 4374 and 4376. USB interface 4360 is connected USB hubs 4361 and 4363. USB hubs 4362, 4364, 4366, 4368, 4370, 4372, 4374 and 4376) are connected to RGB (video) cameras 4370 (e.g., cameras 38). USB Hub 4361 is connected to depth cameras 4365 and 4367. USB hub 4363 is connected to depth camera 4367. Main computer 4330 is also connected to touchscreen UI computer 4304 and reporting computer 4306. Touchscreen UI computer 4304 is connected to touchscreen 4302 (e.g. touchscreen 16). Reporting computer 4306 is connected to dishwasher state sensor 4310, loading side light curtain 4312, loading front light curtain 4314, rinse solenoid valve 4324, unloading side light curtain 4318, unloading front light curtain 4316, loading status LEDs 4322 and unloading status LEDs 4320. Power supplies 4338 and 4340 are connected to and provide power to the components of FIG. 43.

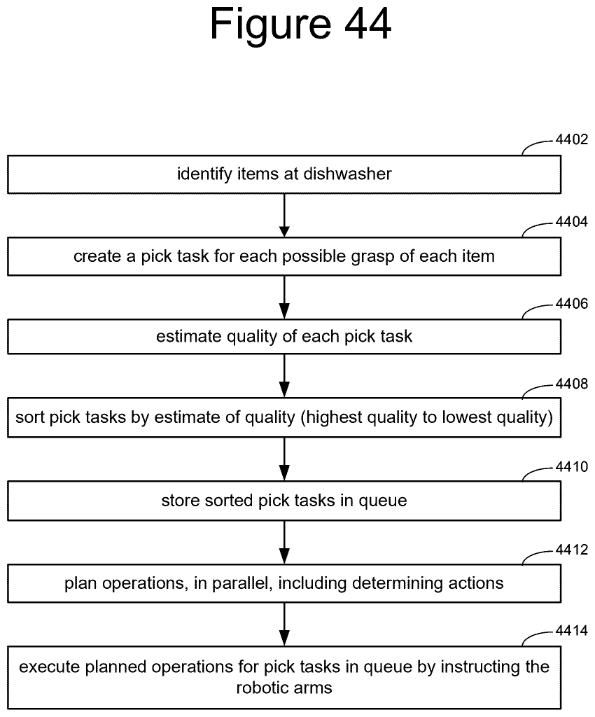

FIG. 44 is a flow chart describing one embodiment of a process for operating the robotic apparatus for arranging tableware, including operating the robotic arms discussed above. In one embodiment, the process of FIG. 44 is performed by main computer 4330. In step 4402, main computer 4330 identifies items of tableware at the dishwasher. For example, using the cameras 38, main computer 4330 identifies dirty plates and cups in bus tub 24. In step 4404, main computer 4330 creates a pick task for each possible grasp of each item of tableware identified in step 4402. In step 4406, main computer 4330 estimates the quality of each pick task. In step 4408, main computer 4330 sorts the pick tasks by estimate of quality (highest quality to lowest quality). In step 4410, main computer 4330 stores sorted pick tasks in a queue. In step 4412, main computer 4330 plans operations, in parallel, including determining actions to be taken. In step 4414, main computer 4330 executes the planned operations for pick tasks by instructing the robotic arms (e.g., robotic arms 12 and 14) via controller 4300.

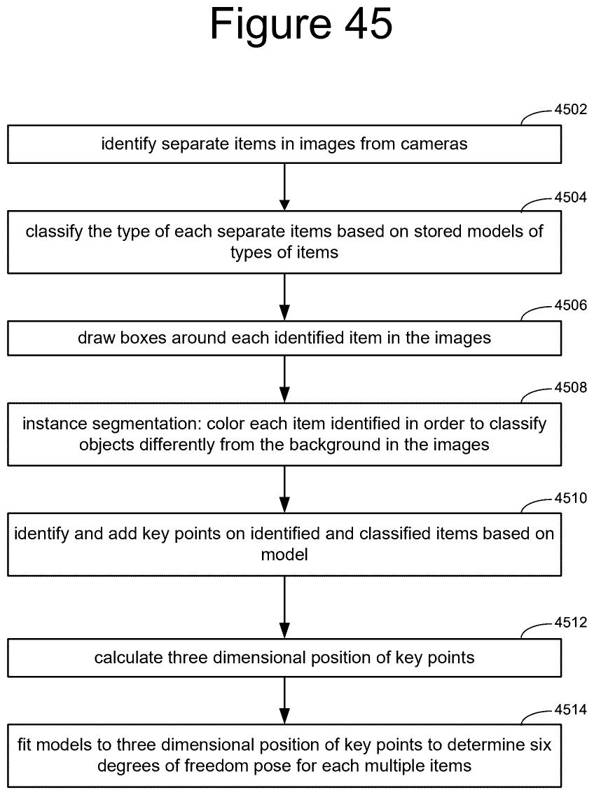

FIG. 45 is a flow chart describing one embodiment of a process for identifying tableware at a dishwasher. In one embodiment, the process of FIG. 45 is an example implementation of step 4402 of FIG. 44. In step 4502, main computer 4330 identifies separate items of tableware in images from the cameras. In step 4504, main computer 4330 classifies the type of each separate item based on the stored models of types of items of tableware. In step 4506, main computer 4330 draws boxes around each identified item in the images. In step 4508, main computer 4330 performs instance segmentation; for example, each item identified is colored a different (or same) color in order to classify objects differently from the background in the images. In step 4510, main computer 4330 identifies and adds key points on identified and classified items based on the models. In step 4512, main computer 4330 calculates three dimensional positions of key points based on where lines of position for a same key point come close to intersecting for the different images. In step 4514, main computer fits respective models to three dimensional positions of key points to determine a six degree-of-freedom pose for each of the multiple items of tableware.

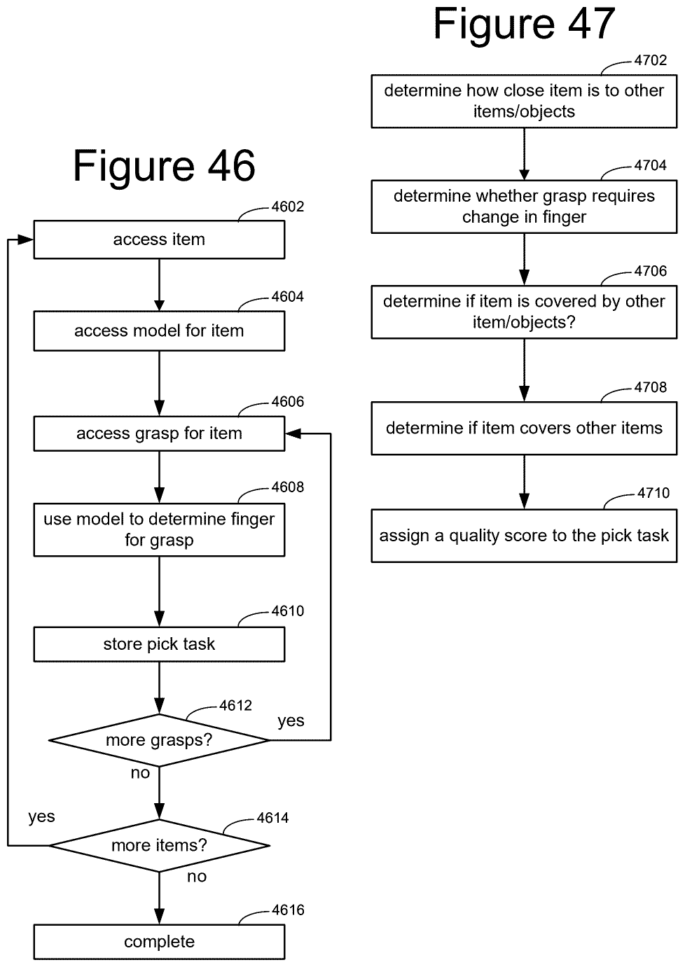

FIG. 46 is a flow chart describing one embodiment of a process for creating pick tasks. In one embodiment, the process of FIG. 46 is an example implementation of step 4404 of FIG. 44. In step 4602, main computer 4330 accesses an item of tableware. In step 4604, main computer accesses a model for the item of tableware accessed in step 4602. In step 4606, main computer 4330 accesses a grasp for the item of tableware accessed in step 4602. In step 4608, main computer 4330 uses the respective model to determine the appropriate finger attachment for the grasp accessed in step 4606. In step 4610, main computer 4330 stores the pick task. If there are more grasps to be accessed, then the process loops back to step 4606; otherwise, in step 4614 it is determined whether there are more items of tableware to process. If there are more items of tableware to process, then the method loops back to step 4602 so the next items of tableware can be processed; otherwise, the method of FIG. 46 is complete (step 4616).

FIG. 47 is a flow chart describing one embodiment of a process for estimating quality of each pick task. In one embodiment, the process of FIG. 47 is an example implementation of step 4406 of FIG. 44. In step 4702, main computer 4330 determines how close an item of tableware is to other items/objects. In step 4704, main computer 4330 determines whether the grasp requires a change in finger attachment. In step 4706, main computer 4330 determines if an item of tableware is covered by other items of tableware or other objects. In step 4708, main computer 4330 determines if the item of tableware covers other items of tableware. Based on evaluating the factors determined in steps 4702-4708, main computer assigns a quality score to the pick task in step 4710.

In another embodiment, a trained neural network can be used to assign quality scores to the pick tasks using visual images and/or output data from depth cameras.

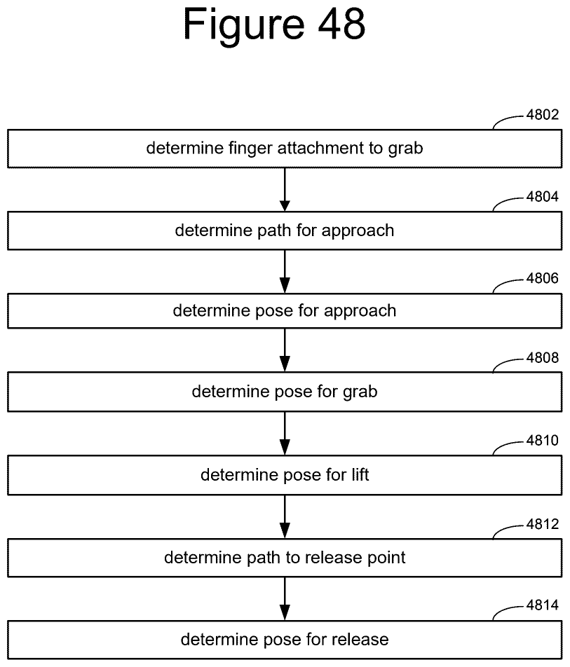

FIG. 48 is a flow chart describing one embodiment of a process for planning, while using collision restraints. In one embodiment, the process of FIG. 48 is an example implementation of step 4412 of FIG. 44. In step 4802, main computer 4330 determines which finger attachment to grab. In step 4804, main computer 4330 determines the path for approach to the item of tableware. In step 4806, main computer 4330 determines pose for approach. In step 4808, main computer 4330 determines the pose of the finger attachment for the grab. In step 4810, main computer 4330 determines pose of the finger attachment for lifting the tableware after grabbing the tableware with the finger attachment. In step 4812, main computer 4330 determines path of the tableware to the release point, including how to move the robot arms to achieve that path. In step 4814, main computer 4330 determines a pose of the finger attachment for the release of the item of tableware at the release point.

In one embodiment, when planning, the system will default to not allow any collision of tableware or robotic arms. For example, the system may require that when moving tableware the tableware being moved cannot be within a minimum distance (e.g., 3 cm) of any other tableware or other object. One exception can be that an item of tableware is allowed to be within the minimum distance of another item of tableware if it is already touching the other item of tableware (e.g., in the tub 24).

In one embodiment, the system may only plan how to pick up an item of tableware prior to picking up the item of tableware. After picking up the item of tableware, the system will plan where to move it to and how to put it down in the dish rack or storage rack.

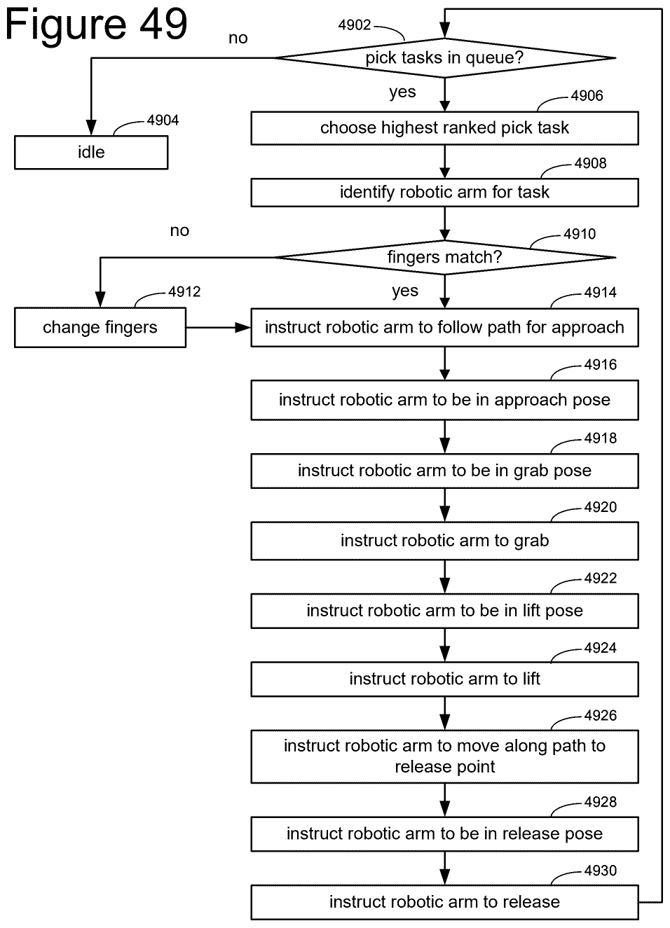

FIG. 49 is a flow chart describing one embodiment of a process for executing planned operations. In one embodiment, the process of FIG. 49 is an example implementation of step 4414 of FIG. 44. In step 4902, main computer 4330 determines whether there are any pick tasks in the queue. If not, the system remains idle in step 4904. If there are pick tasks in the queue, then main computer 4330 chooses the highest ranked pick task. That is, main computer 4330 chooses the pick task with the highest quality score (see step 4710). In step 4908, main computer 4330 identifies the appropriate robotic arm for the pick task (e.g., robotic arm 12 or 14). In step 4910, main computer 4330 determines whether the finger attachment in the pick task is the same as the finger attachment currently installed on the robotic arm identified in step 4908. If not, then main computer 4330 instructs controller 4300 to operate the robotic arm to change finger attachments (e.g., move robotic arm 12 or 14 to an empty holster mount 206 to remove the finger attachment currently installed and move the robotic arm 12 or 14 to the appropriate holster mount 206 to install the desired finger attachment of the pick task). After step 4912, or if the finger attachment does not need to be changed, main computer 4330 instructs controller 4300 to operate the robotic arm to follow the path for approach to the item of tableware associated with the pick task (step 4914). In step 4916, main computer 4330 instructs controller 4300 to operate the robotic arm to be in the approach pose, identified on the pick task for approaching the item of tableware, as the robotic arm approaches the item of tableware. In step 4918, main computer 4330 instructs controller 4300 to operate the robotic arm to be in the grab pose, identified on the pick task for grabbing the item of tableware. In step 4920, main computer 4330 instructs controller 4300 to operate the robotic arm to grab the item of tableware while in the grab pose. In step 4922, main computer 4330 instructs controller 4300 to operate the robotic arm to be in the lift pose, identified on the pick task for lifting the item of tableware. In step 4924, main computer 4330 instructs controller 4300 to operate the robotic arm to lift the item of tableware while in the lift pose. In step 4926, main computer 4330 instructs controller 4300 to operate the robotic arm to move along the path to the release point. In step 4928, main computer 4330 instructs controller 4300 to operate the robotic arm to be in the release pose, identified on the pick task for releasing the item of tableware. In step 4930, main computer 4330 instructs controller 4300 to operate the robotic arm to release the item of tableware while in the release pose.

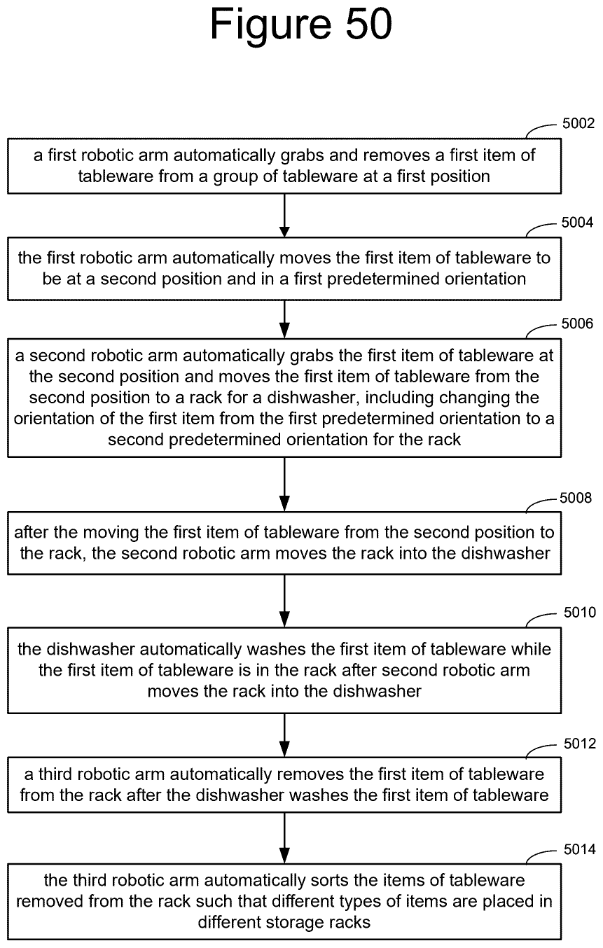

FIG. 50 is a flow chart describing one example of operation of the robotic apparatus for arranging tableware, including operating the robotic arms discussed above, using the processes of FIG. 44-49. In step 5002, a first robotic arm (e.g., robotic arm 12) automatically grabs and removes a first item of tableware from a group of tableware at a first position (e.g., in tub 24). In one embodiment, step 5002 of FIG. 50 corresponds to steps 4914-4924 of FIG. 49. In step 5004, the first robotic arm automatically moves the first item of tableware to be at a second position (e.g., the release point) and in a first predetermined orientation (e.g., the pose for release). In one embodiment, step 5004 of FIG. 50 corresponds to steps 4926-4930 of FIG. 49. Steps 5002 and S004 together are one example pick task.

In step 5006 of FIG. 50, a second robotic arm (e.g., robotic arm 14), different than the first robotic arm, automatically grabs the first item of tableware at the second position (see robotic arms 12 and 14 both holding plate 402 in FIG. 5) and moves the first item of tableware from the second position to a dish rack 302 for a dishwasher, including changing the orientation of the first item from the first predetermined orientation to a second predetermined orientation for the dish rack. In one embodiment, step 5006 of FIG. 50 corresponds to steps 4914-4930 of FIG. 49. Step 5006 is another example of a pick task. Steps 5002-5006 show how one robotic arm picks up the dirty tableware from tub 24 and hands it to the second robotic arm so that the second robotic arm can place the dirty tableware into the dish rack 302. The use of two arms passing the items of tableware between them is more efficient than one arm doing the work by itself.

After the moving the first item of tableware from the second position to the dish rack, the second robotic arm moves the dish rack into the dishwasher 20 in step 5008. In one embodiment, the second robotic arm configures and operates the dishwasher to start and run the dishwasher. In another embodiment, main computer 4330 is connected to the dishwasher and configures and operates the dishwasher to start and run the dishwasher. In step 5010, the dishwasher automatically washes the first item of tableware while the first item of tableware is in the dishrack rack after second robotic arm moves the rack into the dishwasher. In step 5012, a third robotic arm (e.g., robotic arm 3640) automatically removes the first item of tableware (and all other tableware in the dish rack after being washed by the dishwasher) from the dish rack after the dishwasher washes the first item of tableware. In step 5014, the third robotic arm automatically sorts the items of tableware removed from the rack such that different types of items are placed in different storage racks (e.g., 3660, 3662, 3664, and 3666) or other types of containers or surfaces (e.g., surface 3650).

In one set of embodiments, a transformation matrix is set up for transforming coordinates in the coordinate system for the arms to a coordinate system for the environment.

In one set of embodiments, transformation matrices are set up for transforming coordinates in the coordinate system for each of the cameras to the coordinate system for the environment.

In another set of embodiments, the vision (RGB) cameras can all be replaced with depth cameras to create depth maps that are turned in to point clouds, and the system can match key points of the point clouds to the models for the tableware. A RANSAC algorithm can be used to fit the 6DOF pose and use ICP (Iterative Closest Point) to refine the 6DOF pose. Alternatively, a neural network can be trained to use images or a depth map to recognize and determine 6DOF poses for each item of tableware.

A robotic apparatus for arranging tableware has been disclosed that can automatically and more efficiently load dirty tableware into and unload clean tableware from a dishwasher.

A first set of embodiments include a robotic apparatus for arranging tableware, comprising a first robotic arm (e.g., robotic arm 12) and a second robotic arm (e.g., robotic arm 14). The first robotic arm is configured to automatically grab and remove a first item of tableware from a group of tableware at a first position (e.g., in tub 24) and subsequently move the first item of tableware to be at a second position and in a first predetermined orientation. The second robotic arm is configured to automatically grab the first item of tableware at the second position (e.g., see FIG. 5) and move the first item of tableware from the second position to a dish rack for a dishwasher including changing the orientation of the first item from the first predetermined orientation to a second predetermined orientation for the rack.

In one example implementation of the first set of embodiments, the first robotic arm is further configured to automatically grab and remove a second item of tableware from the group of tableware concurrently while the second robotic arm moves the first item of tableware from the second position to the rack.

In one example implementation of the first set of embodiments, the first robotic arm and the second robotic arm are configured to concurrently operate and concurrently move different items of tableware.

In one example implementation of the first set of embodiments, the second robotic arm is further configured to move the rack into the dishwasher after the moving the first item of tableware from the second position to the rack.

In one example implementation of the first set of embodiments, the second robotic arm is configured to automatically grab the first item of tableware at the second position by grabbing the first item of tableware from the first robotic arm such that the first robotic arm and the second robotic arm are grabbing the first item of tableware at a same time.

In one example implementation of the first set of embodiments, the apparatus further comprising a tub, the second robotic arm is configured to automatically grab the first item of tableware at the second position by grabbing the first item of tableware from the tub.

In one example implementation of the first set of embodiments, the apparatus further comprising a third robotic arm, the third robotic arm is configured to automatically remove the first item of tableware from the rack after the dishwasher washes the first item of tableware; the first robotic arm and the third robotic arm are configured to concurrently operate and concurrently move different items of tableware and/or the second robotic arm and the third robotic arm are configured to concurrently operate and concurrently move different items of tableware. In another example implementation, the first robotic arm, the second robotic arm and the third robotic arm are configured to concurrently operate and concurrently move different items of tableware.

In one example implementation of the first set of embodiments, the apparatus further comprising a third robotic arm, the third robotic arm is configured to automatically remove the items of tableware from the rack after the dishwasher washes the items of tableware, the third robotic arm is configured to automatically sort the items of tableware removed from the rack such that different types of items are placed in different containers or onto different surfaces.

In one example implementation of the first set of embodiments, the apparatus further comprising a third robotic arm, the third robotic arm is configured to automatically remove the items of tableware from the rack after the dishwasher washes the items of tableware, the items of tableware include plates and drinkware, the third robotic arm is configured to automatically stack the plates removed from the dishwasher after the dishwasher washes the items of tableware.

In one example implementation of the first set of embodiments, the second robotic arm is further configured to automatically remove the items of tableware from the rack after the dishwasher washes the items of tableware.

In one example implementation of the first set of embodiments, the first robotic arm and the second robotic arm comprise a first coordinated pair of robotic arms configured to load tableware on to the rack without colliding into each other.

In one example implementation of the first set of embodiments, the apparatus further comprising an additional pair of robotic arms configured to load tableware on to the rack without colliding into each other and without colliding into the first coordinated pair of robotic arms.

In one example implementation of the first set of embodiments, the apparatus further comprising a set of interchangeable finger attachments, the first robotic arm includes a motor and a mechanical interface, the interchangeable finger attachments are each configured to separately removably attach to the mechanical interface such that the motor causes the respective finger attachments to move while the fingers are attached to the mechanical interface.

In one example implementation of the first set of embodiments, the mechanical interface includes a first rail connected to the motor and a second rail connected to the motor; and the set of interchangeable finger attachments includes plate bite fingers, the plate bite fingers comprise: a first support connected to the first rail, a second support connected to the second rail, a grabber comprising a bridge connected to the first support, a tongue connected to the bridge at a pivot, and a spring connected to the first support and the tongue, and a paw connected to the second support, the motor is configured to cause the first rail and second rail to move toward each other and away from each other thereby causing the paw to move toward the grabber and away from the grabber, moving the paw toward the grabber is configured to cause the plate bite fingers to grab a plate.

In one example implementation of the first set of embodiments, the mechanical interface (e.g., gripper) includes a first rail connected to the motor and a second rail connected to the motor; and the set of interchangeable finger attachments includes a magnetic finger. The magnetic finger comprises: a first wing connected to the first rail, a second wing connected to the second rail, and multiple magnets connected to the first wing and the second wing, the motor is configured to cause the first rail and second rail to move toward each other and away from each other thereby causing the first wing to move toward the second wing and away from the second wing thereby rotating the magnets, in a first alignment the magnets create a magnetic field to attract a metal utensil, in a second alignment the magnets cancel out the magnetic field to drop the utensil.

In one example implementation of the first set of embodiments, the mechanical interface includes a first rail connected to the motor and a second rail connected to the motor; and the set of interchangeable finger attachments includes plier fingers. The plier fingers comprise: a first support connected to the first rail, a second support connected to the second rail, the second support is connected to the first support at a pivot, a flat tongue connected at an end of the first support, an arched surface connected at an end of the second support, the motor is configured to cause the first rail and second rail to move toward each other and away from each other thereby causing the flat tongue to move toward the arched surface and away from the arched surface, moving the flat tongue toward the arched surface is configured to cause the plier fingers to grab an item of drinkware.

In one example implementation of the first set of embodiments, the mechanical interface includes a first rail connected to the motor and a second rail connected to the motor; and the set of interchangeable finger attachments includes alligator fingers. The alligator fingers comprise: a first support connected to the first rail, the first support includes three hinges, a second support connected to the second rail, the second support is connected to the first support at distal hinge of the three hinges, a tongue connected at the distal hinge of the three hinges, an arched surface connected at a mid section of the second support, the motor is configured to cause the first rail and second rail to move toward each other and away from each other thereby causing the tongue to move toward the arched surface and away from the arched surface, moving the tongue toward the arched surface is configured to cause the alligator fingers to grab an item of drinkware.

In one example implementation of the first set of embodiments, the apparatus further comprising: a control circuit connected to the first robotic arm and the second robotic arm; and a set of cameras connected to the control circuit. The control circuit is configured to identify items of the group of tableware by: identifying separate items in images from cameras; classifying the type of each separate item based on stored models of types of items; coloring each item identified and classified as an object different from a background in the images; identifying and drawing key points on identified and classified items; matching key points for a same item in images from different cameras by determining where lines of position for a same key point come close to intersecting for different images; calculating three dimensional position of key points; and fitting models to three dimensional position of key points to determine six degree-of-freedom poses for each of multiple items.

In one example implementation of the first set of embodiments, the apparatus further comprising: a control circuit connected to the first robotic arm and the second robotic arm. The control circuit configured to identify items of tableware in a bucket at the dishwasher, create a pick task for each possible grasp of each item, estimate the quality of each pick task, sort pick tasks by the estimate of quality, plan operations for multiple pick tasks in parallel, including determining of actions, and execute planned operations for pick tasks in queue by instructing the robotic arms, the planned operations include the first robotic arm and the second robotic arm moving the first item to the rack.

A second set of embodiments including a method for arranging tableware, comprising a first robotic arm automatically grabbing and removing a first item of tableware from a group of tableware at a first position; the first robotic arm automatically moving the first item of tableware to be at a second position and in a first predetermined orientation; and a second robotic arm automatically grabbing the first item of tableware at the second position and moving the first item of tableware from the second position to a rack for a dishwasher, including changing the orientation of the first item from the first predetermined orientation to a second predetermined orientation for the rack.

In one example implementation of the second set of embodiments, the method further comprising after the moving the first item of tableware from the second position to the rack, the second robotic arm moving the rack into the dishwasher.

In one example implementation of the second set of embodiments, the method further comprising a third robotic arm automatically removing the first item of tableware from the rack after the dishwasher washes the first item of tableware.

In one example implementation of the second set of embodiments, the method further comprising the dishwasher automatically washing the first item of tableware while the first item of tableware is in the rack after second robotic arm moves the rack into the dishwasher; and a third robotic arm automatically removing the first item of tableware from the rack after the dishwasher washes the first item of tableware.

In one example implementation of the second set of embodiments, the second robotic arm automatically grabbing the first item of tableware at the second position comprises the second robotic arm automatically grabbing the first item of tableware from the first robotic arm such that the first robotic arm and the second robotic arm are grabbing the first item of tableware at a same time.

In one example implementation of the second set of embodiments, the method further comprising rinsing the first item of tableware in a rinse container before the second robotic arm automatically grabs the first item of tableware, the second position is at the rinse container, the second robotic arm grabs the first item of tableware from the rinse container.

A third set of embodiments includes an apparatus for arranging tableware, comprising: means for automatically grabbing and removing a first item of tableware from a group of tableware at a first position; means for automatically moving the first item of tableware to be at a second position and in a first predetermined orientation; means for automatically grabbing the first item of tableware at the second position and moving the first item of tableware from the second position to a rack for a dishwasher, including changing the orientation of the first item from the first predetermined orientation to a second predetermined orientation for the rack; means for automatically moving the rack into the dishwasher; and means for automatically removing the first item of tableware from the rack after the dishwasher washes the first item of tableware and placing the first item at a location specified for the first item.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via one or more intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

1. A robotic apparatus for arranging tableware, comprising:
a first robotic arm, the first robotic arm is configured to automatically grab and remove a first item of tableware from a group of tableware at a first position and subsequently move the first item of tableware to be at a second position and in a first predetermined orientation; and
a second robotic arm, the second robotic arm is configured to automatically grab the first item of tableware at the second position and move the first item of tableware from the second position to a tableware holder for a dishwasher including changing the orientation of the first item from the first predetermined orientation to a second predetermined orientation for the tableware holder.

2. The robotic apparatus of claim 1, wherein:
the first robotic arm is further configured to automatically grab and remove a second item of tableware from the group of tableware concurrently while the second robotic arm moves the first item of tableware from the second position to the tableware holder.

3. The robotic apparatus of claim 1, wherein:
the first robotic arm and the second robotic arm are configured to concurrently operate and concurrently move different items of tableware.

4. The robotic apparatus of claim 1, wherein:
the tableware holder is a rack for the dishwasher; and
the second robotic arm is further configured to move the rack into the dishwasher after moving the first item of tableware from the second position to the rack.

5. The robotic apparatus of claim 1, wherein:
the second robotic arm is configured to automatically grab the first item of tableware at the second position by grabbing the first item of tableware from the first robotic arm such that the first robotic arm and the second robotic arm are grabbing the first item of tableware at a same time.

6. The robotic apparatus of claim 1, further comprising:
a tub, the first robotic arm is configured to automatically grab the first item of tableware at the first position by grabbing the first item of tableware from the tub.

7. The robotic apparatus of claim 1, further comprising:
a third robotic arm, the third robotic arm is configured to automatically remove the first item of tableware from the tableware holder after the dishwasher washes the first item of tableware.

8. The robotic apparatus of claim 7, wherein:
the first robotic arm and the third robotic arm are configured to concurrently operate and concurrently move different items of tableware.

9. The robotic apparatus of claim 7, wherein:
the second robotic arm and the third robotic arm are configured to concurrently operate and concurrently move different items of tableware.

10. The robotic apparatus of claim 7, wherein:
the first robotic arm, the second robotic arm and the third robotic arm are configured to concurrently operate and concurrently move different items of tableware.

11. The robotic apparatus of claim 1, further comprising:
a third robotic arm, the third robotic arm is configured to automatically remove the items of tableware from the tableware holder after the dishwasher washes the items of tableware, the third robotic arm is configured to automatically sort the items of tableware removed from the tableware holder such that different types of items are placed in different containers or on different surfaces.

12. The robotic apparatus of claim 1, further comprising:
a third robotic arm, the tableware holder is a rack for the dishwasher, the third robotic arm is configured to automatically remove the items of tableware from the rack after the dishwasher washes the items of tableware, the items of tableware include plates and drinkware, the third robotic arm is configured to automatically stack the plates removed from the dishwasher after the dishwasher washes the items of tableware.

13. The robotic apparatus of claim 1, wherein:
the second robotic arm is further configured to automatically remove the items of tableware from the tableware holder after the dishwasher washes the items of tableware.

14. The robotic apparatus of claim 1, wherein:
the first robotic arm and the second robotic arm comprise a first coordinated pair of robotic arms configured to load tableware on to the tableware holder without colliding into each other.

15. The robotic apparatus of claim 14, further comprising:
an additional pair of robotic arms configured to load tableware on to the tableware holder without colliding into each other and without colliding into the first coordinated pair of robotic arms.

16. The robotic apparatus of claim 1, further comprising:
a set of interchangeable finger attachments, the first robotic arm includes a motor and a mechanical interface, the interchangeable finger attachments are each configured to separately removably attach to the mechanical interface such that the motor causes the respective finger attachments to move while the finger attachments are attached to the mechanical interface.

17. The robotic apparatus of claim 16, wherein:
the mechanical interface includes a first rail connected to the motor and a second rail connected to the motor; and
the set of interchangeable finger attachments includes plate bite fingers, the plate bite fingers comprise:
a first support connected to the first rail,
a second support connected to the second rail,
a grabber comprising a bridge connected to the first support, a tongue connected to the bridge at a pivot, and a spring connected to the first support and the tongue, and
a paw connected to the second support, the motor is configured to cause the first rail and second rail to move toward each other and away from each other thereby causing the paw to move toward the grabber and away from the grabber, moving the paw toward the grabber is configured to cause the plate bite fingers to grab a plate.

18. The robotic apparatus of claim 16, wherein:
the mechanical interface includes a first rail connected to the motor and a second rail connected to the motor; and
the set of interchangeable finger attachments includes a magnetic finger, the magnetic finger comprises:
a first wing connected to the first rail,
a second wing connected to the second rail, and
multiple magnets connected to the first wing and the second wing, the motor is configured to cause the first rail and second rail to move toward each other and away from each other thereby causing the first wing to move toward the second wing and away from the second wing thereby rotating the magnets, in a first alignment the magnets create a magnetic field to attract a metal utensil, in a second alignment the magnets cancel out the magnetic field to drop the utensil.

19. The robotic apparatus of claim 16, wherein:
the mechanical interface includes a first rail connected to the motor and a second rail connected to the motor; and
the set of interchangeable finger attachments includes plier fingers, the plier fingers comprise:
a first support connected to the first rail,
a second support connected to the second rail, the second support is connected to the first support at a pivot,
a flat tongue connected at an end of the first support,
an arched surface connected at an end of the second support, the motor is configured to cause the first rail and second rail to move toward each other and away from each other thereby causing the flat tongue to move toward the arched surface and away from the arched surface, moving the flat tongue toward the arched surface is configured to cause the plier fingers to grab an item of drinkware.

20. The robotic apparatus of claim 16, wherein:
the mechanical interface includes a first rail connected to the motor and a second rail connected to the motor; and
the set of mechanical fingers includes alligator fingers, the alligator fingers comprise:
a first support connected to the first rail, the first support includes three hinges,
a second support connected to the second rail, the second support is connected to the first support at distal hinge of the three hinges,
a tongue connected at the distal hinge of the three hinges,
an arched surface connected at a mid section of the second support, the motor is configured to cause the first rail and second rail to move toward each other and away from each other thereby causing the tongue to move toward the arched surface and away from the arched surface, moving the tongue toward the arched surface is configured to cause the alligator fingers to grab an item of drinkware.

21. The robotic apparatus of claim 1, further comprising:
a control circuit connected to the first robotic arm and the second robotic arm; and
a set of cameras connected to the control circuit, the control circuit configured to identify items of the group of tableware by:
identifying separate items in images from cameras;
classifying the type of each separate item based on stored models of types of items;
coloring each item identified and classified as an object different from a background in the images;
identifying and drawing key points on identified and classified items;
matching key points for a same item in images from different cameras by determining where lines of position for a same key point come close to intersecting for different images;
calculating three dimensional position of key points; and
fitting models to three dimensional position of key points to determine a six degree-of-freedom pose for each of multiple items.

22. The robotic apparatus of claim 1, further comprising:
a control circuit connected to the first robotic arm and the second robotic arm, the control circuit configured to
identify items of tableware in a bucket at the dishwasher,
create a pick task for each possible grasp of each item,
estimate the quality of each pick task,
sort pick tasks by the estimate of quality,
plan operations for multiple pick tasks in parallel, including determining of actions, and
execute planned operations for pick tasks in queue by instructing the robotic arms, the planned operations include the first robotic arm and the second robotic arm moving the first item to the rack.

23. A method for arranging tableware, comprising:
a first robotic arm automatically grabbing and removing a first item of tableware from a group of tableware at a first position;
the first robotic arm automatically moving the first item of tableware to be at a second position and in a first predetermined orientation; and
a second robotic arm automatically grabbing the first item of tableware at the second position and moving the first item of tableware from the second position to a dish for a dishwasher, including changing the orientation of the first item from the first predetermined orientation to a second predetermined orientation for the rack.

24. The method of claim 23, further comprising:
after the moving the first item of tableware from the second position to the dish rack, the second robotic arm moving the dish rack into the dishwasher.

25. The method of claim 24, further comprising:
a third robotic arm automatically removing the first item of tableware from the dish rack after the dishwasher washes the first item of tableware.

26. The method of claim 23, further comprising:
the dishwasher automatically washing the first item of tableware while the first item of tableware is in the dish rack after the second robotic arm moves the rack into the dishwasher; and
a third robotic arm automatically removing the first item of tableware from the dish rack after the dishwasher washes the first item of tableware.

27. The method of claim 26, wherein:
the second robotic arm automatically grabbing the first item of tableware at the second position comprises the second robotic arm automatically grabbing the first item of tableware from the first robotic arm such that the first robotic arm and the second robotic arm are grabbing the first item of tableware at the same time.

28. The method of claim 23, further comprising:
rinsing the first item of tableware in a rinse container before the second robotic arm automatically grabs the first item of tableware, the second position is at the rinse container, the second robotic arm grabs the first item of tableware from the rinse container.

29. An apparatus for arranging tableware, comprising:
means for automatically grabbing and removing a first item of tableware from a group of tableware at a first position;
means for automatically moving the first item of tableware to be at a second position and in a first predetermined orientation;
means for automatically grabbing the first item of tableware at the second position and moving the first item of tableware from the second position to a rack for a dishwasher, including changing the orientation of the first item from the first predetermined orientation to a second predetermined orientation for the rack;
means for automatically moving the rack into the dishwasher; and
means for automatically removing the first item of tableware from the rack after the dishwasher washes the first item of tableware and placing the first item at a location specified for the first item.
